(19) United States
(12) Patent Application Publication
(10) Pub. No.: US 2025/0287200 A1
(43) Pub. Date: Sep. 11, 2025

(54) CODING CONFIGURATIONS TO ACHIEVE PHYSICAL LAYER SECURITY

(71) Applicant: QUALCOMM Incorporated, San Diego, CA (US)

(72) Inventors: Ahmed ELSHAFIE, San Diego, CA (US); Alexandros MANOLAKOS, Escondido, CA (US); Hung Dinh LY, San Diego, CA (US); Wanshi CHEN, San Diego, CA (US)

(21) Appl. No.: 19/105,018

(22) PCT Filed: Sep. 29, 2023
(86) PCT No.: PCT/US2023/075618

§ 371 Date: Feb. 19, 2025

(30) Foreign Application Priority Data
Oct. 5, 2022 (GR) 20220100819

(51) Int. Cl. H04W 12/03; H04L 1/00; H04L 27/00; H04W 72/20

(52) U.S. Cl. CPC H04W 12/03; H04L 1/0003; H04L 27/0008; H04W 72/20

(57) ABSTRACT

Methods, systems, and devices for wireless communication are described. In a wireless communications system, a transmitting device (e.g., a network node, a user equipment (UE)) may modulate data using a configuration that corresponds to a particular modulation and coding scheme (MCS) or a modulation order that represents a mapping or bundling of a set of constellation points to a single point for transmitting the data in a message. In some examples, the configuration for modulating the data may be based on a target secure block error rate (BLER). For example, the transmitting device may select an MCS to achieve the target secrecy BLER from an MCS table or from a set of MCSs indicated to the transmitting device. In some examples, the transmitting device may determine an MCS for modulating the data to achieve the target secure BLER based on an indicated MCS and an delta MCS.

The present Application is a 371 national stage filing of International PCT Application No. PCT/US2023/075618 by Elshafie et al., entitled “CODING CONFIGURATIONS TO ACHIEVE PHYSICAL LAYER SECURITY,” filed Sep. 29, 2023; and claims priority to Greece Patent Application No. 20220100819 by Elshafie et al., entitled “CODING CONFIGURATIONS TO ACHIEVE PHYSICAL LAYER SECURITY,” filed Oct. 5, 2022, each of which is assigned to the assignee hereof, and each of which is expressly incorporated by reference in its entirety herein.

### FIELD OF TECHNOLOGY

The present disclosure relates to wireless communication, including coding configurations to achieve physical layer (PHY) security.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a transmitting device may use physical layer (PHY) security to secure communications over a particular channel. In some cases, techniques for securing a channel according to a target secrecy rate may be improved.

### SUMMARY

The described techniques relate to improved methods, systems, devices, and apparatuses that support coding configurations to achieve physical layer (PHY) security. For example, the described techniques provide for data modulation according to a secrecy rate. A transmitting device (e.g., a network node, a user equipment (UE)) may receive control signaling indicating one or more configurations for modulating data to be transmitted to a receiving device (e.g., a UE). In some cases, the transmitting device may select a first configuration of the one or more configurations, where a first configuration includes a mapping of constellation points to a single constellation point for transmitting the data in a message based on a modulation and coding scheme (MCS) associated with a target secrecy block error rate (BLER). For example, the transmitting device may select a secure MCS from an MCS table based on how a corresponding secrecy rate compares to the target secure BLER. Additionally, or alternatively, the control signaling may indicate an MCS and a delta MCS, which the transmitting device may use to determine the secure MCS. The transmitting device may modulate the data according to the selected first configuration, the modulating including mapping the constellation points to achieve the target secrecy BLER (e.g., using an MCS or a modulation order). In addition, the transmitting device may transmit the message to the receiving device based on the modulated data, which may be secure from illegitimate entities.

A method for wireless communication at a transmitting device is described. The method may include receiving control signaling indicating one or more configurations for modulating data, selecting a first configuration of the one or more configurations based on the control signaling, where the first configuration comprises a mapping of constellation points to a single constellation point for transmitting the data in a message based on an MCS associated with a target secrecy BLER, modulating the data in accordance with the selected first configuration based on the mapping of the constellation points to achieve the target secrecy BLER, and transmitting, to a receiving device, the message based on the modulated data.

An apparatus for wireless communication at a transmitting device is described. The apparatus may include a processor, memory coupled with the processor, and instructions stored in the memory. The instructions may be executable by the processor to cause the apparatus to receive control signaling indicating one or more configurations for modulating data, select a first configuration of the one or more configurations based on the control signaling, where the first configuration comprises a mapping of constellation points to a single constellation point for transmitting the data in a message based on an MCS associated with a target secrecy BLER modulate the data in accordance with the selected first configuration based on the mapping of the constellation points to achieve the target secrecy BLER, and transmit, to a receiving device, the message based on the modulated data.

Another apparatus for wireless communication at a transmitting device is described. The apparatus may include means for receiving control signaling indicating one or more configurations for modulating data, means for selecting a first configuration of the one or more configurations based on the control signaling, where the first configuration comprises a mapping of constellation points to a single constellation point for transmitting the data in a message based on an MCS associated with a target secrecy BLER, means for modulating the data in accordance with the selected first configuration based on the mapping of the constellation points to achieve the target secrecy BLER, and means for transmitting, to a receiving device, the message based on the modulated data.

A non-transitory computer-readable medium storing code for wireless communication at a transmitting device is described. The code may include instructions executable by a processor to receive control signaling indicating one or more configurations for modulating data, select a first configuration of the one or more configurations based on the control signaling, where the first configuration comprises a mapping of constellation points to a single constellation point for transmitting the data in a message based on an MSC associated with a target secrecy BLER, modulate the data in accordance with the selected first configuration based on the mapping of the constellation points to achieve the target secrecy BLER, and transmit, to a receiving device, the message based on the modulated data.

Some examples of the method, apparatuses, and non-transitory computer-readable medium described herein may further include operations, features, means, or instructions for selecting the target secrecy BLER, a first MCS associated with a first secrecy rate that may be lower than the target secrecy BLER, and a second MCS associated with a second secrecy rate that may be higher than the first secrecy rate and transmitting, to the receiving device, the message based a modulation of the data in accordance with the second MCS.

In some examples of the method, apparatuses, and non-transitory computer-readable medium described herein, receiving the control signaling may include operations, features, means, or instructions for receiving the control signaling indicating at least a first MCS, a second MCS, one or more delta MCSs for the second MCS relative to the first MCS, one or more delta modulation orders for the second MCS relative to the first MCS, or a combination thereof.

Some examples of the method, apparatuses, and non-transitory computer-readable medium described herein may further include operations, features, means, or instructions for transmitting, to the receiving device, a message indicating a selected delta MCS of the one or more delta MCSs based on the control signaling.

In some examples of the method, apparatuses, and non-transitory computer-readable medium described herein, receiving the control signaling may include operations, features, means, or instructions for receiving the control signaling indicating a delta MCS for at least a data security level, a data security priority, a data priority, a packet delay budget (PDB), a delay of the data, or a combination thereof.

Some examples of the method, apparatuses, and non-transitory computer-readable medium described herein may further include operations, features, means, or instructions for receiving, from the receiving device, a report indicating a set of channel quality indicators (CQIs) and a set of corresponding MCSs, where a first CQI of the set of CQIs and a first MCS of the set of corresponding MCSs may be associated with a secrecy rate based on the target secrecy BLER.

Some examples of the method, apparatuses, and non-transitory computer-readable medium described herein may further include operations, features, means, or instructions for receiving, from the receiving device, a report indicating at least a set of delta MCSs, a set of delta CQIs, or both.

Some examples of the method, apparatuses, and non-transitory computer-readable medium described herein may further include operations, features, means, or instructions for transmitting, to the receiving device, a configuration message indicating a configuration of at least the set of delta MCSs, the set of delta CQIs, or both for a resource pool based on at least a security priority, a security level, a data priority, a PDB, or a combination thereof.

Some examples of the method, apparatuses, and non-transitory computer-readable medium described herein may further include operations, features, means, or instructions for receiving, from the receiving device, a report indicating a set of MCS tables and a set of BLERs, where the set of BLERs includes a secrecy BLER and a link BLER.

Some examples of the method, apparatuses, and non-transitory computer-readable medium described herein may further include operations, features, means, or instructions for transmitting, to the receiving device, control signaling indicating a configuration of at least one or more MCSs, one or more delta MCSs, or both.

Some examples of the method, apparatuses, and non-transitory computer-readable medium described herein may further include operations, features, means, or instructions for receiving, from the receiving device, control signaling indicating a configuration of at least one or more MCSs, one or more delta MCSs, or both.

In some examples of the method, apparatuses, and non-transitory computer-readable medium described herein, the transmitting device may be a first user equipment (UE) and where the receiving device may be a second UE.

In some examples of the method, apparatuses, and non-transitory computer-readable medium described herein, the transmitting device may be a network entity and where the receiving device may be a UE.

A method for wireless communication at a receiving device is described. The method may include receiving control signaling indicating one or more configurations for modulating data, receiving, from a transmitting device, a message based on a first configuration of the one or more configurations that comprises a mapping of constellation points to a single constellation point for receiving the data in the message based on an MCS associated with a target secrecy BLER.

An apparatus for wireless communication at a receiving device is described. The apparatus may include a processor, memory coupled with the processor, and instructions stored in the memory. The instructions may be executable by the processor to cause the apparatus to receive control signaling indicating one or more configurations for modulating data, and receive, from a transmitting device, a message based on a first configuration of the one or more configurations that comprises a mapping of constellation points to a single constellation point for receiving the data in the message based on an MCS associated with a target secrecy BLER.

Another apparatus for wireless communication at a receiving device is described. The apparatus may include means for receiving control signaling indicating one or more configurations for modulating data, and means for receiving, from a transmitting device, a message based on a first configuration of the one or more configurations that comprises a mapping of constellation points to a single constellation point for receiving the data in the message based on an MCS associated with a target secrecy BLER.

A non-transitory computer-readable medium storing code for wireless communication at a receiving device is described. The code may include instructions executable by a processor to receive control signaling indicating one or more configurations for modulating data, and receive, from a transmitting device, a message based on a first configuration of the one or more configurations that comprises a mapping of constellation points to a single constellation point for receiving the data in the message based on an MCS associated with a target secrecy BLER.

In some examples of the method, apparatuses, and non-transitory computer-readable medium described herein, receiving the message may include operations, features, means, or instructions for receiving, from the transmitting device, the message based on a modulation of the data in accordance with a second MCS associated with a second secrecy rate that may be higher than a first secrecy rate associated with a first MCS.

In some examples of the method, apparatuses, and non-transitory computer-readable medium described herein, receiving the control signaling may include operations, features, means, or instructions for receiving the control signaling indicating at least a first MCS, a second MCS, one or more delta MCSs for the second MCS relative to the first MCS, one or more delta modulation orders for the second MCS relative to the first MCS, or a combination thereof.

Some examples of the method, apparatuses, and non-transitory computer-readable medium described herein may further include operations, features, means, or instructions for receiving, from the transmitting device, a message indicating a selected delta MCS of the one or more delta MCSs based on the control signaling.

In some examples of the method, apparatuses, and non-transitory computer-readable medium described herein, receiving the control signaling may include operations, features, means, or instructions for receiving the control signaling indicating a delta MCS for at least a data security level, a data security priority, a data priority, a PDB, a delay of the data, or a combination thereof.

Some examples of the method, apparatuses, and non-transitory computer-readable medium described herein may further include operations, features, means, or instructions for transmitting, to the transmitting device, a report indicating a set of CQIs and a set of corresponding MCSs, where a first CQI of the set of CQIs and a first MCS of the set of corresponding MCSs may be associated with a secrecy rate based on the target secrecy BLER.

Some examples of the method, apparatuses, and non-transitory computer-readable medium described herein may further include operations, features, means, or instructions for transmitting, to the transmitting device, a report indicating at least a set of delta MCSs, a set of delta CQIs, or both.

Some examples of the method, apparatuses, and non-transitory computer-readable medium described herein may further include operations, features, means, or instructions for transmitting, to the transmitting device, a configuration message indicating a configuration of at least the set of delta MCSs, the set of delta CQIs, or both for a resource pool based on at least a security priority, a security level, a data priority, a PDB, or a combination thereof.

Some examples of the method, apparatuses, and non-transitory computer-readable medium described herein may further include operations, features, means, or instructions for transmitting, to the transmitting device, a report indicating a set of MCS tables and a set of BLERs, where the set of BLERs includes a secrecy BLER and a link BLER.

Some examples of the method, apparatuses, and non-transitory computer-readable medium described herein may further include operations, features, means, or instructions for receiving, from the transmitting device, control signaling indicating a configuration of at least one or more MCSs, one or more delta MCSs, or both.

Some examples of the method, apparatuses, and non-transitory computer-readable medium described herein may further include operations, features, means, or instructions for transmitting, to the transmitting device, control signaling indicating a configuration of at least one or more MCSs, one or more delta MCSs, or both.

In some examples of the method, apparatuses, and non-transitory computer-readable medium described herein, the transmitting device may be a first UE and where the receiving device may be a second UE.

In some examples of the method, apparatuses, and non-transitory computer-readable medium described herein, the transmitting device may be a network entity and where the receiving device may be a UE.

### BRIEF DESCRIPTION OF THE DRAWINGS

FIG. 1 illustrates an example of a wireless communications system that supports coding configurations to achieve physical layer (PHY) security in accordance with one or more aspects of the present disclosure.

FIG. 2 illustrates an example of a wireless communications system that supports coding configurations to achieve PHY security in accordance with one or more aspects of the present disclosure.

FIG. 3 illustrates an example of a sidelink channel state information (CSI) report that supports coding configurations to achieve PHY security in accordance with one or more aspects of the present disclosure.

FIG. 4 illustrates an example of a process flow that supports coding configurations to achieve PHY security in accordance with one or more aspects of the present disclosure.

FIGS. 5 and 6 show block diagrams of devices that support coding configurations to achieve PHY security in accordance with one or more aspects of the present disclosure.

FIG. 7 shows a block diagram of a communications manager that supports coding configurations to achieve PHY security in accordance with one or more aspects of the present disclosure.

FIG. 8 shows a diagram of a system including a device that supports coding configurations to achieve PHY security in accordance with one or more aspects of the present disclosure.

FIGS. 9 and 10 show block diagrams of devices that support coding configurations to achieve PHY security in accordance with one or more aspects of the present disclosure.

FIG. 11 shows a block diagram of a communications manager that supports coding configurations to achieve PHY security in accordance with one or more aspects of the present disclosure.

FIG. 12 shows a diagram of a system including a device that supports coding configurations to achieve PHY security in accordance with one or more aspects of the present disclosure.

FIGS. 13 through 18 show flowcharts illustrating methods that support coding configurations to achieve PHY security in accordance with one or more aspects of the present disclosure.

### DETAILED DESCRIPTION

Physical layer (PHY) security may be used in different wireless communications systems to secure channels and communications between numerous devices. For example, a transmitting device (e.g., a network node or a network entity, a user equipment (UE)) may use PHY security to achieve a maximum secrecy rate, which may be based on a secrecy rate of a legitimate channel between a transmitting device and a receiving device compared to a secrecy rate of an eavesdropping channel between the transmitting device and an eavesdropper (e.g., an illegitimate entity). In some examples, an instantaneous secrecy rate may be lower than a target secrecy rate (e.g., a secrecy outage probability), which may lead to information leakage to the eavesdropper. While some systems may employ random binning encoding to achieve near perfect security, others may use simpler metrics intended to reduce functionalities of the eavesdropper, such as a data rate. However, such designs may fail to guarantee perfect security.

The techniques described herein support coding configurations for PHY security. A transmitting device (e.g., a network node, a sidelink UE) may modulate data using a configuration that corresponds to a particular modulation and coding scheme (MCS), a modulation order, or some other modulation that represents a mapping or bundling of a set of constellation points to a single point for transmitting the data in a message. In some examples, the configuration for modulating the data may be based on a target secure block error rate (BLER). For example, the transmitting device may select an MCS to achieve the target secrecy BLER from an MCS table or from a set of MCSs indicated to the transmitting device. In some examples, a receiving device may transmit control signaling to the transmitting device indicating an MCS and a delta MCS, and in some cases, a channel quality indicator (CQI) and a delta CQI. The transmitting device may determine an MCS (or a CQI) to use for modulating the data to achieve the target secure BLER based on the indicated MCS and delta MCS (or the indicated CQI and delta CQI). Modulating the data in this way, the transmitting device may reduce a data rate, resulting in a lower secrecy outage probability (e.g., secure BLER). In addition, such modulation may improve secrecy of the message transmission, resulting in less leakage to illegitimate entities and thus, a more secure wireless communications system.

Aspects of the disclosure are initially described in the context of wireless communications systems. Aspects of the disclosure are then described in the context of sidelink channel state information (CSI) reports and process flows. Aspects of the disclosure are further illustrated by and described with reference to apparatus diagrams, system diagrams, and flowcharts that relate to coding configurations to achieve PHY security.

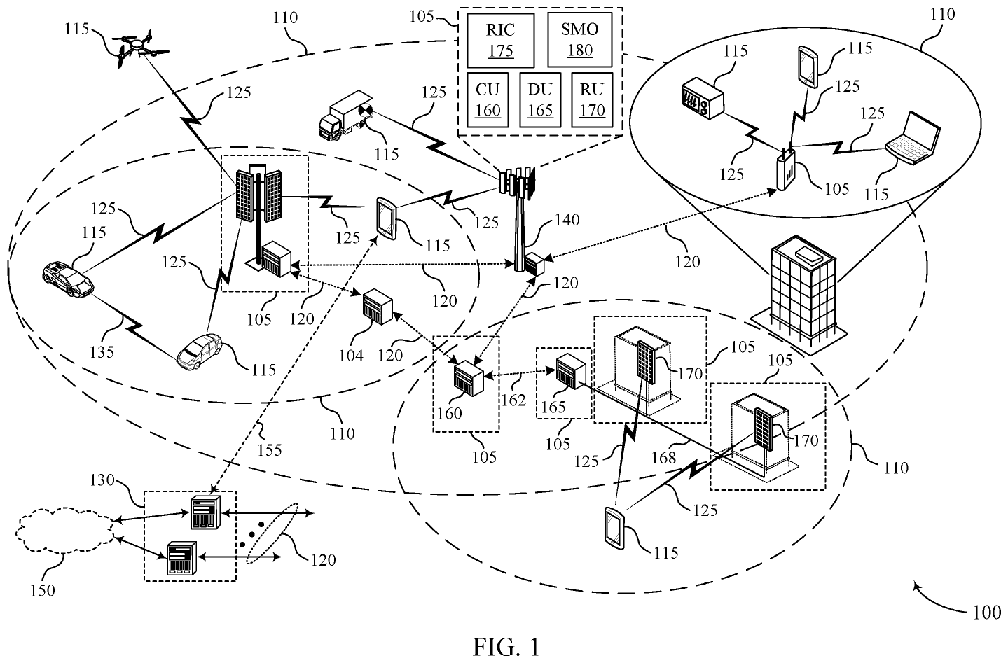

FIG. 1 illustrates an example of a wireless communications system 100 that supports coding configurations to achieve PHY security in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network node, a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support coding configurations to achieve PHY security as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined PHY structure for supporting the communication links 125. For example, a carrier used for a communication link 125 may include a portion of a RF spectrum band (e.g., a bandwidth part (BWP)) that is operated according to one or more PHY channels for a given radio access technology (e.g., LTE, LTE-A, LTE-A Pro, NR). Each PHY channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δ_{f}) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems, communications may be secured using upper layer cryptographic security or PHY security. Upper layer cryptographic security (e.g., cryptography) may have a computational advantage over other types of security. For example, in cases where an eavesdropper has limited computational power for decryption, a message may be secured using cryptography such that a decryption key changes over time and is more difficult for such an eavesdropper to decode. As such, the cryptography may exhaust the computational power and similar capabilities of illegitimate entities (e.g., eavesdroppers). Alternatively, some systems may use a spread spectrum security. For example, in a CDMA system, each UE 115 may have a particular assigned code associated with its data. If there are many UEs 115 in the system, only a UE 115 corresponding to a same CDMA code as its data may easily decode that data, securing the system with a knowledge advantage. In this way, spread spectrum security may exhaust searching power of illegitimate entities.

Some wireless communications systems may use PHY security to secure communications, which may be associated with a channel advantage. PHY security may be used to secure channels and communications such as downlink control information (DCI) and uplink control information (UCI), communications between IoT devices, and positioning signals against attacks. In this way, PHY security may exhaust decoding capabilities of illegitimate entities. In some examples, if channel conditions between a transmitting device and a receiving device are better than channel conditions between the transmitting device and an eavesdropper, the transmitting device may use particular coding such that it may achieve a security with zero percent leakage of information to the eavesdropper. For example, a transmitting device (e.g., Alice, A), a receiving device (e.g., Bob, B), and an eavesdropper (e.g., Eve, E) may communicate via a wiretap channel, where the eavesdropper eavesdrops on data the receiving device sends to the transmitting device. In such a system, a maximum achievable secrecy rate R_{sec} may be given by R_{sec}=[R_{A-B}−R_{A-E}]⁺=max{R_{A-B}−R_{A-E}, 0}, where R_{A-B} may represent a rate of a legitimate channel between the transmitting device and receiving device (e.g., Alice and Bob), and R_{A-E} may represent a rate of an eavesdropping channel between the transmitting device and the eavesdropper (e.g., Alice and Eve). As such, the maximum achievable secrecy rate may represent an amount of mutual information between the legitimate channel and the eavesdropping channel, and may indicate an amount of perfectly secured bits the transmitting device may send to the receiving device and expect zero percent leakage to the eavesdropper.

In some examples, a transmitting device may use random binning coding to achieve a particular secrecy rate. The legitimate channel between the transmitting device and receiving device may support a given quantity of bits based on a rate of the legitimate channel, C_{B}, where C_{B} may be equivalent to R_{A-R} (e.g., a rate of information shared between Alice and Bob). For example, if C_{B}=log₂ 64=6 bits/s, the legitimate channel may support a modulation order of 64 a coding rate (e.g., information rate) of 6 bits/s. In addition, the eavesdropping channel between the transmitting device and the eavesdropper may support a rate C_{E}, where C_{E} may be equivalent to R_{A-E} (e.g., a rate of information shared between Alice and Eve). For example, if C_{E}=log₂ 16=4 bits/s, the eavesdropper may obtain information from the legitimate channel with a modulation order of 16 and at a coding rate of 4 bits/s. In this way, a quantity of bits the eavesdropper may attack from the legitimate channel with a low error rate is 4 bits/s (e.g., the eavesdropper may be limited to reliably receiving 2⁴=16 messages via the eavesdropping channel), while the transmitting device may transmit at most 2⁶=64 messages to the receiving device via the legitimate channel.

Based on C_{B} and C_{E}, the eavesdropper may obtain one message from the transmitting device and via the eavesdropping channel per four messages transmitted from the transmitting device to the receiving device via the legitimate channel. For example, a constellation corresponding to the transmitting device may include 64 constellation points, each constellation point representing a message. The constellation points may be grouped into subsets of four constellation points, each of the four constellation points representing a different message (e.g., message 1, message 2, message 3, message 4). Based on the rate of the legitimate channel between the transmitting device and the receiving device of 6 bits/s, the transmitting device may determine which message to transmit to the receiving device (e.g., message 4) and randomly select a corresponding constellation point of a subset of the constellation corresponding to that message for transmission to the receiving device. In this way, the receiving device may receive and decode each type of message separately and reliably.

Alternatively, based on C_{E}, the eavesdropper's constellation may include 16 constellation points, each constellation point representing a message. When the transmitting device transmits a single message to the receiving device, the eavesdropper sees that message as one of four possible messages corresponding to a single constellation point of its constellation (e.g., one constellation point of the eavesdropper's constellation includes four constellation points of the transmitting device's constellation). As such, the eavesdropper receives a message that has an equal likelihood of carrying message 1, message 2, message 3, or message 4, thus making it difficult for the eavesdropper to successfully decode a message intended for the receiving device (e.g., the chance of the eavesdropper successfully decoding the message is one fourth). That is, the eavesdropper may receive four different messages at a same location and time with a high amount of noise that makes it difficult for the eavesdropper to distinguish between the four messages. In this way, the signal (e.g., including data, information, and the like) received at the eavesdropper may fail to help the eavesdropper determine the message sent to the receiving device.

In some examples, information leakage to an eavesdropper may occur when an instantaneous secrecy rate is lower than a target secrecy rate (e.g., R_{sec}). A secrecy outage probability, also referred to as a secure BLER, may represent the probability that the instantaneous secrecy rate is lower than the target secrecy rate. For perfectly-secured systems, the secure BLER may be near zero (e.g., almost no information leakage). The higher a security level of a system (e.g., the more the security level strength), the lower the secure BLER. However, higher security may result in a lower data rate as security is maintained by effectively hiding data under dummy bits of transmissions.

A transmitting device may achieve perfect security by maintaining a secrecy rate using coding rates as described herein to adjust random binning encoder parameters (e.g., instantaneous secrecy rate and link rate). Otherwise, a secrecy outage may occur. That is, the transmitting device may use a target secrecy rate, where information leakage may occur if an instantaneous secrecy rate is lower than the target secrecy rate. In some examples, to reduce design complexity and avoid using random binning coding, a simple metric may be used that may fail to guarantee perfect secrecy. For example, some security schemes may be targeted to reduce a signal interference-to-noise ratio (SINR) or a data rate of the eavesdropper, increase a BLER, or the like. That is, some security techniques may attempt to reduce functionalities of the eavesdropper, which may fail to prevent leakage to the eavesdropper in some cases. As such, a security design configured to enable random binning under particular security levels (e.g., defined by a secrecy outage probability or a BLER) may improve a security rate of communications between a transmitting device and a receiving device.

The wireless communications system 100 may support coding configurations for PHY security. A transmitting device (e.g., a network entity 105, a UE 115) may receive control signaling indicating one or more configurations for modulating data to be transmitted to a receiving device (e.g., a UE 115). In some cases, the transmitting device may select a first configuration of the one or more configurations, where the first configuration includes a mapping of constellation points to a single constellation point for transmitting the data in a message based on an MCS associated with a target secrecy BLER. For example, the transmitting device may select a secure MCS from an MCS table based on how a corresponding secrecy rate compares to the target secure BLER. Additionally, or alternatively, the control signaling (e.g., RRC signaling, a MAC control element (MAC-CE)) may indicate an MCS and a delta MCS, which the transmitting device may use to determine the secure MCS. The transmitting device may modulate the data according to the first configuration, the modulating including mapping the constellation points to achieve the target secrecy BLER (e.g., using an MCS or a modulation order). In addition, the transmitting device may transmit the message to the receiving device based on the modulated data, which may be secure from illegitimate entities.

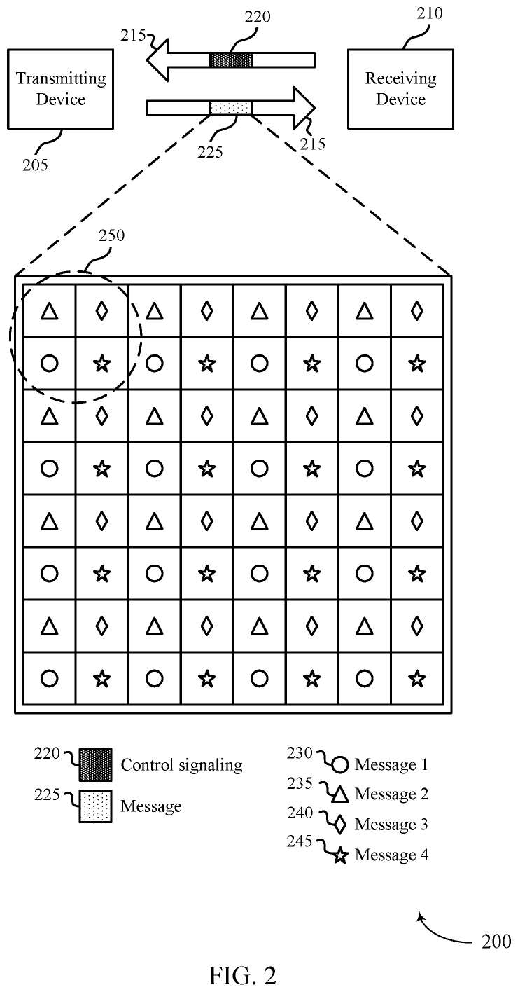

FIG. 2 illustrates an example of a wireless communications systems 200 that supports coding configurations to achieve PHY security in accordance with one or more aspects of the present disclosure. In some examples, the wireless communications system 200 may implement aspects of the wireless communications system 100 or may be implemented by aspects of the wireless communications system 100. For example, the wireless communications system 200 may include a transmitting device 205 and a receiving device 210, which may be examples of corresponding devices as described herein. In some examples, the transmitting device 205 may be a network entity 105 or a UE 115 (e.g., a sidelink UE), and the receiving device 210 may be a UE 115 (e.g., a UE 115 capable of performing at least uplink, downlink, or sidelink communications, or a combination thereof).

The wireless communications system 200 may support communications between the transmitting device 205 and the receiving device 210. For example, the transmitting device 205 and the receiving device 210 may communicate uplink and downlink signaling via communication links 215, which may be examples of the communication links 125 described herein with reference to FIG. 1. In some cases, the communication links 215 may be secured such that there is very little or no information leakage of data or information to an eavesdropper (e.g., an illegitimate entity).

After encoding data, the transmitting device 205 may modulate the data using a first modulation scheme (e.g., quadrature-amplitude modulation (QAM), pulse-amplitude modulation (PAM), amplitude-shift keying (ASK), or the like). In some examples, the first modulation scheme may be a high modulation representing an MCS, a modulation order, or some other modulation that represents a mapping or bundling of a set of constellation points into a single constellation point to be transmitted as a message 225 to the receiving device 210.

In some cases, the bundling or mapping the constellation points (e.g., QAM points) into a single constellation point may be configured and indicated to the transmitting device (e.g., via RRC or MAC-CE signaling). The transmitting device 205 may receive an indication of multiple modulation configurations via RRC signaling, down-select the configurations via a MAC-CE, and select a configuration to use for modulating the data via DCI (e.g., a scheduling or non-scheduling DCI or via a wakeup signal (WUS)). For example, the transmitting device 205 may receive control signaling 220 indicating one or more configurations for modulating data, where a configuration may include a mapping of constellation points to a single constellation point for transmitting data in a message. The mapping may be based on an MCS associated with a target secrecy BLER. In some examples, the transmitting device 205 may select a first configuration of the one or more configurations based on the control signaling 220.

The transmitting device 205 may modulate the data in accordance with the first configuration, where the modulation includes mapping the constellation points to a single constellation point to achieve the target secrecy BLER. For example, the transmitting device 205 may convert the data from a 64 QAM system to a 4 QAM system. In some examples, the transmitting device 205 may modulate the data according to a particular MCS. The transmitting device 205 may transmit a message 225 to the receiving device 210, the message 225 including the modulated data.

In some cases, the transmitting device 205 may modulate the data and transmit the message 225 such that the data is secured from eavesdroppers or other illegitimate devices. For example, the transmitting device 205 may be configured to transmit four different message types, including a message 230 (e.g., message 1), a message 235 (e.g., message 2), a message 240 (e.g., message 3), and a message 245 (e.g., message 4). The transmitting device 205 may apply an MCS to the messages such that a group of messages 250 includes one of each type of message. That is, the transmitting device 205 may transmit the group of messages 250 to the receiving device 210, and the receiving device 210, based on the control signaling 220, may know how to decode the message 225 (e.g., which may be the message 230, the message 235, the message 240, or the message 245). Alternatively, an illegitimate device eavesdropping on the communication link 215 may be unable to decode the group of messages 250 as it may be unaware of which message the transmitting device 205 is actually transmitting.

In some examples, the transmitting device 205 may select a target link rate for the communication links 215 that may achieve the target secrecy BLER (e.g., a target secrecy outage probability). In addition, the transmitting device 205 may select an MCS that is associated with a secrecy rate lower than the target secrecy BLER. The secrecy rate may be lower than a link rate associated with the communication links 215. That is, the transmitting device 205 may select the target secrecy BLER, a first MCS (e.g., MCS_scheduled) associated with a first secrecy rate that is lower than the target secrecy BLER, and a second MCS (e.g., MCS_secure) associated with a second secrecy rate that is higher than the first secrecy rate. The transmitting device 205 may modulate the data in accordance with the second MCS based on the second MCS providing more security to communications over the communication links 215.

The MCSs associated with each configuration may have a corresponding delta. In some cases, the transmitting device 205 may define a delta MCS relative to the first MCS (e.g., MCS_scheduled). If the first MCS and the second MCS differ in modulation order only (the code rate being the same), the transmitting device 205 may define a delta modulation order for the second MCS relative to the first MCS. The MCSs, delta MCSs, delta modulation orders, or a combination thereof may be configured and indicated via a two-bit indication in RRC signaling, a MAC-CE, or DCI (e.g., scheduling or non-scheduling). For example, the transmitting device 205 may receive the control signaling 220 that indicates bits 00 for a first delta MCS (e.g., Delta 1), bits 01 for a second delta MCS (e.g., Delta 2), bits 10 for a third delta MCS (e.g., Delta 3), or bits 11 for a fourth delta MCS (e.g., Delta 4). Alternatively, the control signaling 220 may include DCI that indicates at least the first MCS (e.g., MCS_scheduled), a second MCS (e.g., MCS_secure), one or more delta MCSs for the second MCS relative to the first MCS, one or more delta modulation orders for the second MCS relative to the first MCS, or a combination thereof.

In some examples, the control signaling 220 may include a MAC-CE or RRC signaling that indicates one or multiple delta MCSs between the first MCS and the second MCS. In addition, a DCI (e.g., a non-scheduling DCI or a WUS) may indicate the first MCS and one delta MCS which implicitly indicates the second MCS. That is, the transmitting device 205 may use the first MCS and the delta MCS defined in the MAC-CE, the RRC signaling, or the DCI to compute the second MCS. In some examples, a delta MCS may be configured per data security level at a given time (e.g., high, medium, and low, among other security levels), a data security priority at a given time (e.g., multiple priorities may be defined for security), a data priority (e.g., L1 priority, L2 priority, or both), a remaining packet delay budget (PDB) or a delay of a packet, or any combination thereof. The transmitting device 205 may transmit a message to the receiving device 210 indicating a selected delta MCS (e.g., from the set of delta MCSs indicated to the transmitting device 205 in the DCI), or the message may indicate the set of delta MCSs from which the receiving device 210 may select a delta MCS.

In some examples, the receiving device 210 may compute a set of CQIs and a set of corresponding MCSs for a CSI reference signal (CSI-RS) report. For example, the receiving device 210 may compute and report a first CQI (e.g., CQI_legacy) and a corresponding first MCS that may be associated with a high secrecy BLER or a relatively unsecure channel. In addition, the receiving device 210 may compute and report a second CQI (e.g., CQI_secure) and a corresponding second MCS (e.g., MCS_secure) to achieve a particular secrecy rate that is under the target secrecy BLER (e.g., target secrecy outage probability) selected by the transmitting device 205. In such cases, the secrecy rate associated with the second CQI and the corresponding second MCS may be agreed on between the transmitting device 205 and the receiving device 210, and the transmitting device 205 may use the secure CQI and the secure MCS to map the constellation points.

In its CSI-RS report, the receiving device 210 may include both the first CQI and the second CQI, where the second CQI may be indicated as a delta CQI from the first CQI. Alternatively, the first CQI and the second CQI may differ in modulation order only. In some cases, the receiving device 210 may indicate delta MCSs, delta CQIs, or both (e.g., preferred by the receiving device 210), or the receiving device 210 may update one or more delta MCSs, one or more delta CQIs, or both. The receiving device 210 may indicate preferred or updated delta MCSs and delta CQIs to the transmitting device 205 via RRC signaling, a MAC-CE, UCI, or UE assistance information (UAI) (e.g., RRC signaling or generally some L1, L2, or layer 3 (L3) signaling).

In some cases, the transmitting device 205 may select a configuration or an MCS to use for modulating the data from a set of MCS tables and based on the target secrecy BLER. For example, the receiving device 210 may transmit the CSI-RS report to the transmitting device 205 indicating a set of MCS tables and a set of BLERs that includes a secrecy BLER and a link BLER. In some examples, an MCS table may include just modulation orders without a coding rate (e.g., if the coding rate does not change between different configurations for the modulated data). That is, the transmitting device 205 may use just a secure modulation order to map the constellation points to a single constellation point for transmitting the data in the message 225.

In cases where the transmitting device 205 and the receiving device 210 are both sidelink UEs, the transmitting device 205 and the receiving device 210 may agree on the set of delta MCSs using RRC signaling while an RRC connection is established between the devices. In addition, the transmitting device 205, the receiving device 210, or both may use the control signaling 220 to configure MCSs (e.g., the first MCS and the second MCS), one or more delta MCSs, or both, where the control signaling 220 may include L1 signaling (e.g., sidelink control information (SCI)), L2 signaling (e.g., PC5 MAC-CE signaling), or L3 signaling (e.g., PC5 RRC signaling). That is, the transmitting device 205 may transmit the control signaling 220 indicating a configuration of at least one or more MCSs, one or more delta MCSs, or both to the receiving device 210, or the receiving device 210 may transmit such control signaling 220 to the transmitting device 205. In some examples, one or more MCS tables for different secrecy BLERs may be configured using the RRC connection established between the transmitting device 205 and the receiving device 210 when both devices are sidelink UEs.

By mapping or bundling the constellation points in this way, the transmitting device 205 may increase the security of communications between the transmitting device 205 and the receiving device 210. For example, the mapping may result in a lower secure outage (e.g., lower secure BLER), which may result in higher secrecy in the wireless communications system 200. In addition, by selecting an MCS to use for modulating the data based on a corresponding secrecy BLER, the transmitting device 205 may ensure that the data is modulated to achieve at least the target secrecy BLER.

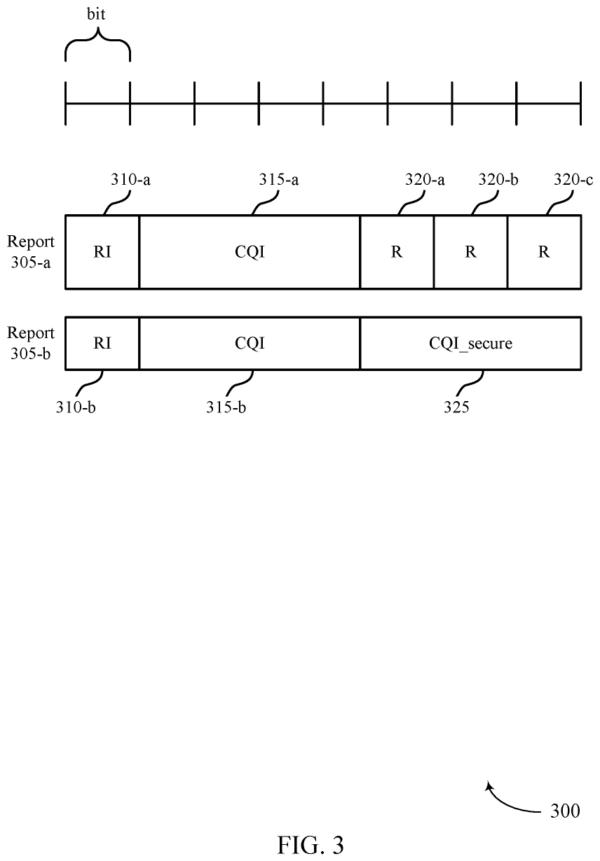

FIG. 3 illustrates an example of a sidelink CSI report 300 that supports coding configurations to achieve PHY security in accordance with one or more aspects of the present disclosure. In some examples, the sidelink CSI report 300 may implement aspects of the wireless communications systems 100 and 200 or may be implemented by aspects of the wireless communications systems 100 and 200. For example, a transmitting device and a receiving device, which may both be sidelink UEs, may communicate the sidelink CSI report 300 to indicate MCSs and CQIs to use for modulating data according to a target secrecy BLER.

As described with reference to FIG. 2, a receiving device may compute a set of CQIs and a set of corresponding MCSs for the sidelink CSI report 300. For example, the receiving device may compute and report a first CQI (e.g., CQI_legacy) and a corresponding first MCS that may be associated with a high secrecy BLER or a relatively unsecure channel. In addition, the receiving device may compute and report a second CQI (e.g., CQI_secure) and a corresponding second MCS (e.g., MCS_secure) to achieve a particular secrecy rate that is under the target secrecy BLER (e.g., target secrecy outage probability) selected by the transmitting device. In such cases, the secrecy rate associated with the second CQI and the corresponding second MCS may be agreed on between the transmitting device and the receiving device. In the sidelink CSI report 300, the receiving device may include both the first CQI and the second CQI, where the second CQI may be indicated as a delta CQI from the first CQI. Alternatively, the first CQI and the second CQI may differ in modulation order only.

In some examples, the transmitting device and the receiving device may communicate sidelink CSI report 300 via a MAC-CE. In some cases, the sidelink CSI report 300 may indicate at least a set of delta MCSs, a set of delta CQIs, or both. For example, the sidelink CSI report 300 may include a report 305-a and a report 305-b, where the report 305-a may include one bit indicating a rank 310-a (e.g., RI), four bits indicating a CQI 315-a (e.g., CQI_legacy), and three bits indicating a reserved bit 320, including a reserved bit 320-a, a reserved bit 320-b, and a reserved bit 320-c. The report 305-b may utilize the reserved bits 320 to indicate a secure CQI. For example, the report 305-b may include one bit indicating a rank 310-b (e.g., RI), four bits indicating a CQI 315-b (e.g., CQI_legacy), and three bits indicating a secure CQI 325 (e.g., CQI_secure).

In some cases, the transmitting device may configure at least one or more delta MCSs, one or more delta CQIs, or both per resource pool based on at least a security priority, a security level, a data priority, a remaining PDB, or a combination thereof. For example, the receiving device may report a CQI 315 (e.g., a regular CQI) and a delta CQI, which the transmitting device may use to compute the secure CQI 325.

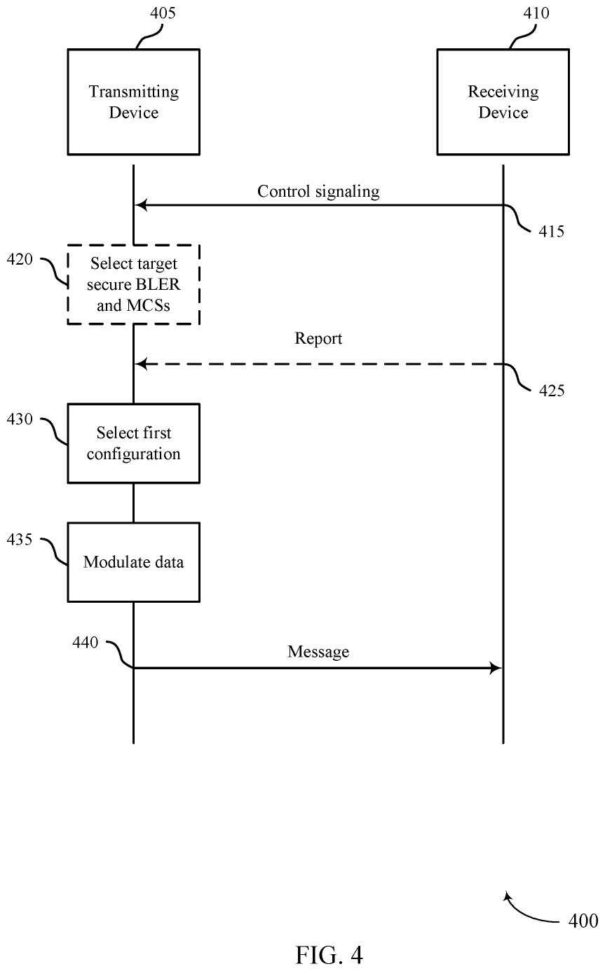

FIG. 4 illustrates an example of a process flow 400 that supports coding configurations to achieve PHY security in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a transmitting device 405 and a receiving device 410, which may be examples of corresponding devices described herein. In some examples, the transmitting device 405 and the receiving device 410 may both be sidelink UEs, or the transmitting device 405 may be a network node and the receiving device 410 may be a UE. In the following description of the process flow 400, the operations between the transmitting device 405 and the receiving device 410 may be transmitted in a different order than the example order shown, or the operations performed by the transmitting device 405 and the receiving device 410 may be performed in different orders or at different times. Some operations may also be omitted from the process flow 400, and other operations may be added to the process flow 400.

At 415, the transmitting device 405 may receive, from the receiving device 410, control signaling indicating one or more configurations for modulating data. In some cases, the control signaling may include at least DCI, RRC signaling, a MAC-CE, or a combination thereof.

At 420, the transmitting device 405 may select the target secrecy BLER, a first MCS associated with a first secrecy rate that is lower than the target secrecy BLER, and a second MCS associated with a second secrecy rate that is higher than the first secrecy rate. That is, the transmitting device 405 may select and use the second MCS (e.g., MCS_secure) for modulating the data, where the second MCS achieves the target secrecy BLER as it is more secure than the first MCS (e.g., MCS_scheduled).

At 425, the transmitting device 405 may receive, from the receiving device 410, a report (e.g., a CSI-RS report) indicating a set of CQIs and a set of corresponding MCSs, where a first MCS of the set of corresponding MCSs are associated with a secrecy rate that is based on the target secrecy BLER. Additionally, or alternatively, the report may indicate at least a set of delta MCSs, a set of delta CQIs, or both. For example, if the report includes the first MCS (e.g., a regular MCS) and a delta MCS, the transmitting device 205 may determine the second MCS by applying the delta MCS to the first MCS.

At 430, the transmitting device 405 may select a first configuration of the one or more configurations based on the control signaling, where the first configuration includes a mapping of constellation points to a single constellation point for transmitting the data in a message based on an MCS associated with the target secrecy BLER. In some examples, the transmitting device 405 may select the first configuration based on the first configuration achieving the target secrecy BLER. In some cases, the transmitting device 405 may select the first configuration from an MCS table based on the target secrecy BLER.

At 435, the transmitting device 405 may modulate the data in accordance with the selected first configuration based on the mapping of the constellation points to achieve the target secrecy BLER. For example, the transmitting device 405 may convert a 64 QAM system to a 4 QAM system.

At 440, the transmitting device 405 may transmit, to the receiving device 410, the message based on the modulated data. That is, as the data is modulated as described herein, the message transmission to the receiving device 410 may be secured from illegitimate users (e.g., eavesdroppers). In some examples, the transmitting device 405 may transmit the message based on a modulation of the data in accordance with the second MCS.

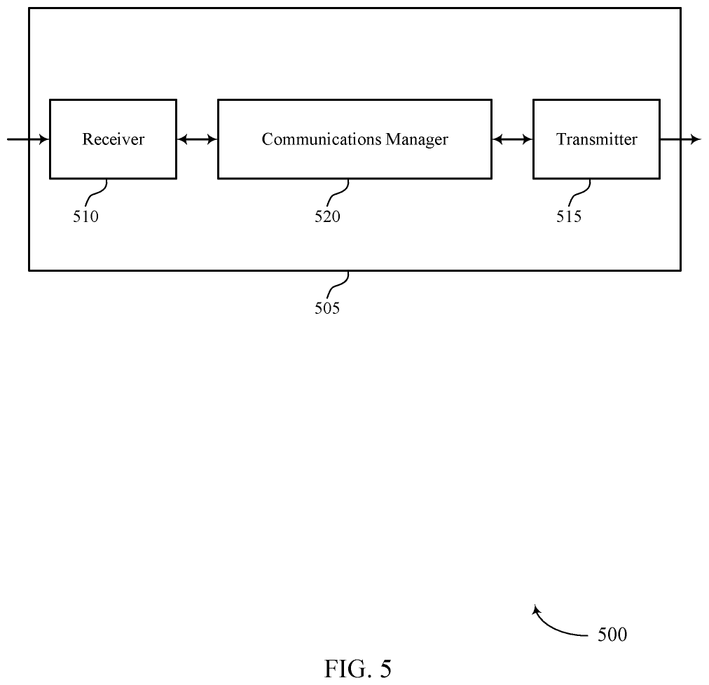

FIG. 5 shows a block diagram 500 of a device 505 that supports coding configurations to achieve PHY security in accordance with one or more aspects of the present disclosure. The device 505 may be an example of aspects of a transmitting device as described herein. The device 505 may include a receiver 510, a transmitter 515, and a communications manager 520. The device 505 may also include one or more processors, memory coupled with the one or more processors, and instructions stored in the memory that are executable by the one or more processors to enable the one or more processors to perform the PHY security features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to coding configurations to achieve PHY security). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to coding configurations to achieve PHY security). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of coding configurations to achieve PHY security as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a transmitting device in accordance with examples as disclosed herein. For example, the communications manager 520 may be configured as or otherwise support a means for receiving control signaling indicating one or more configurations for modulating data. The communications manager 520 may be configured as or otherwise support a means for selecting a first configuration of the one or more configurations based on the control signaling, where the first configuration includes a mapping of constellation points to a single constellation point for transmitting the data in a message based on an MCS associated with a target secrecy BLER. The communications manager 520 may be configured as or otherwise support a means for modulating the data in accordance with the selected first configuration based on the mapping of the constellation points to achieve the target secrecy BLER. The communications manager 520 may be configured as or otherwise support a means for transmitting, to a receiving device, the message based on the modulated data.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for modulating data to achieve a target secrecy BLER, which may improve the security of communications between a transmitting device and a receiving device and reduce information leakage to eavesdroppers.

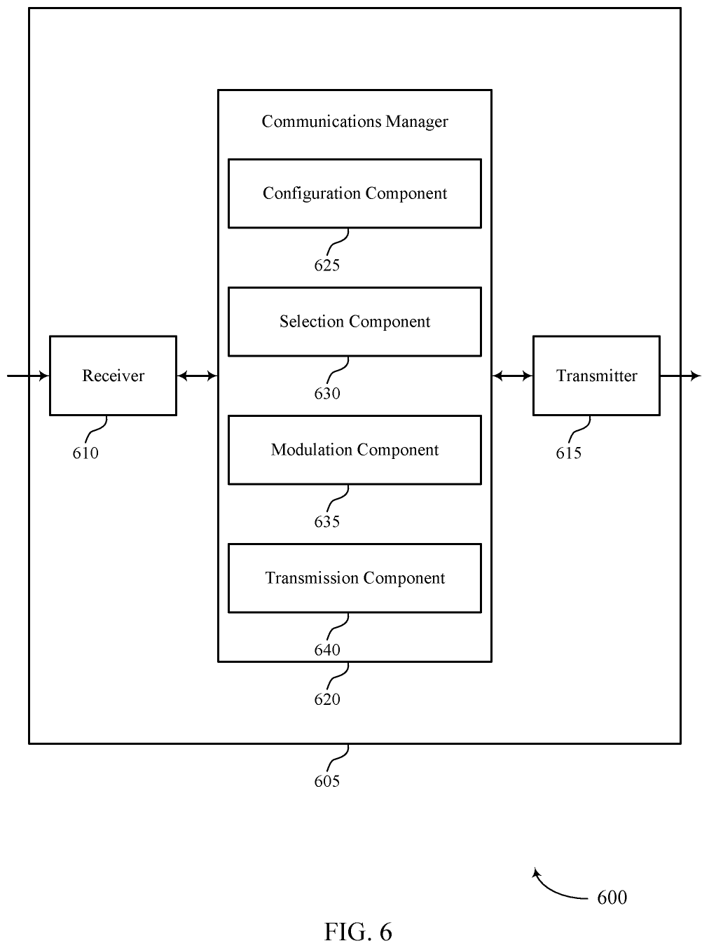

FIG. 6 shows a block diagram 600 of a device 605 that supports coding configurations to achieve PHY security in accordance with one or more aspects of the present disclosure. The device 605 may be an example of aspects of a device 505 or a transmitting device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to coding configurations to achieve PHY security). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to coding configurations to achieve PHY security). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of coding configurations to achieve PHY security as described herein. For example, the communications manager 620 may include a configuration component 625, a selection component 630, a modulation component 635, a transmission component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a transmitting device in accordance with examples as disclosed herein. The configuration component 625 may be configured as or otherwise support a means for receiving control signaling indicating one or more configurations for modulating data. The selection component 630 may be configured as or otherwise support a means for selecting a first configuration of the one or more configurations based on the control signaling, where the first configuration includes a mapping of constellation points to a single constellation point for transmitting the data in a message based on an MCS associated with a target secrecy BLER. The modulation component 635 may be configured as or otherwise support a means for modulating the data in accordance with the selected first configuration based on the mapping of the constellation points to achieve the target secrecy BLER. The transmission component 640 may be configured as or otherwise support a means for transmitting, to a receiving device, the message based on the modulated data.

In some cases, the configuration component 625, the selection component 630, the modulation component 635, and the transmission component 640 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 625, the selection component 630, the modulation component 635, and the transmission component 640 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

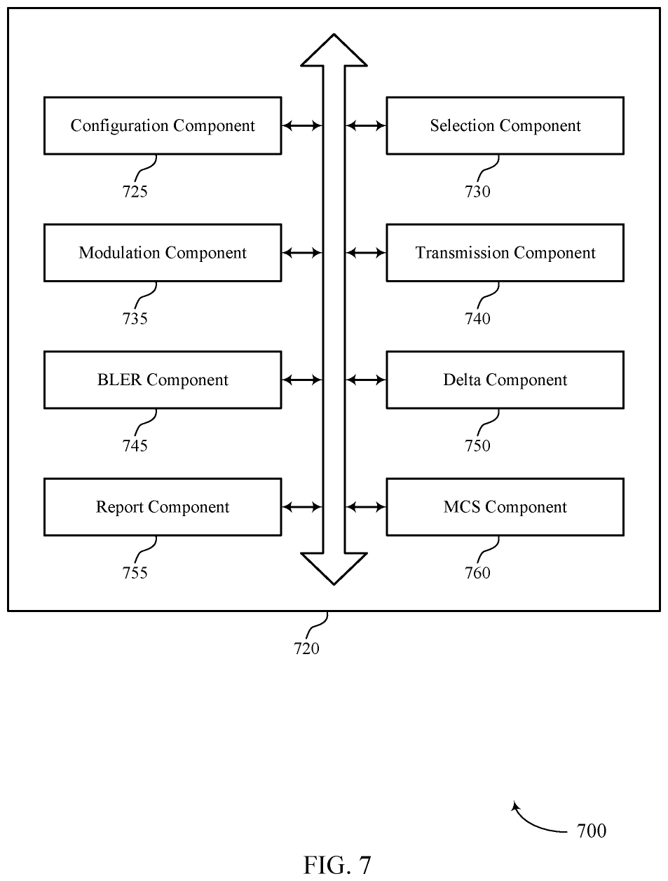

FIG. 7 shows a block diagram 700 of a communications manager 720 that supports coding configurations to achieve PHY security in accordance with one or more aspects of the present disclosure. The communications manager 720 may be an example of aspects of a communications manager 520, a communications manager 620, or both, as described herein. The communications manager 720, or various components thereof, may be an example of means for performing various aspects of coding configurations to achieve PHY security as described herein. For example, the communications manager 720 may include a configuration component 725, a selection component 730, a modulation component 735, a transmission component 740, a BLER component 745, a delta component 750, a report component 755, an MCS component 760, or any combination thereof. Each of these components may communicate, directly or indirectly, with one another (e.g., via one or more buses).

The communications manager 720 may support wireless communication at a transmitting device in accordance with examples as disclosed herein. The configuration component 725 may be configured as or otherwise support a means for receiving control signaling indicating one or more configurations for modulating data. The selection component 730 may be configured as or otherwise support a means for selecting a first configuration of the one or more configurations based on the control signaling, where the first configuration includes a mapping of constellation points to a single constellation point for transmitting the data in a message based on an MCS associated with a target secrecy BLER. The modulation component 735 may be configured as or otherwise support a means for modulating the data in accordance with the selected first configuration based on the mapping of the constellation points to achieve the target secrecy BLER. The transmission component 740 may be configured as or otherwise support a means for transmitting, to a receiving device, the message based on the modulated data.

In some examples, the BLER component 745 may be configured as or otherwise support a means for selecting the target secrecy BLER, a first MCS associated with a first secrecy rate that is lower than the target secrecy BLER, and a second MCS associated with a second secrecy rate that is higher than the first secrecy rate. In some examples, the transmission component 740 may be configured as or otherwise support a means for transmitting, to the receiving device, the message based on a modulation of the data in accordance with the second MCS.

In some examples, to support receiving the control signaling, the delta component 750 may be configured as or otherwise support a means for receiving the control signaling indicating at least a first MCS, a second MCS, one or more delta MCSs for the second MCS relative to the first MCS, one or more delta modulation orders for the second MCS relative to the first MCS, or a combination thereof.

In some examples, the delta component 750 may be configured as or otherwise support a means for transmitting, to the receiving device, a message indicating a selected delta MCS of the one or more delta MCSs based on the control signaling.

In some examples, to support receiving the control signaling, the delta component 750 may be configured as or otherwise support a means for receiving the control signaling indicating a delta MCS for at least a data security level, a data security priority, a data priority, a PDB, a delay of the data, or a combination thereof.

In some examples, the report component 755 may be configured as or otherwise support a means for receiving, from the receiving device, a report indicating a set of CQIs and a set of corresponding MCSs, where a first CQI of the set of CQIs and a first MCS of the set of corresponding MCSs are associated with a secrecy rate based on the target secrecy BLER.

In some examples, the report component 755 may be configured as or otherwise support a means for receiving, from the receiving device, a report indicating at least a set of delta MCSs, a set of delta CQIs, or both.

In some examples, the report component 755 may be configured as or otherwise support a means for transmitting, to the receiving device, a configuration message indicating a configuration of at least the set of delta MCSs, the set of delta CQIs, or both for a resource pool based on at least a security priority, a security level, a data priority, a PDB, or a combination thereof.

In some examples, the report component 755 may be configured as or otherwise support a means for receiving, from the receiving device, a report indicating a set of MCS tables and a set of BLERs, where the set of BLERs includes a secrecy BLER and a link BLER.

In some examples, the MCS component 760 may be configured as or otherwise support a means for transmitting, to the receiving device, control signaling indicating a configuration of at least one or more MCSs, one or more delta MCSs, or both.

In some examples, the MCS component 760 may be configured as or otherwise support a means for receiving, from the receiving device, control signaling indicating a configuration of at least one or more MCSs, one or more delta MCSs, or both.

In some examples, the transmitting device is a first UE and where the receiving device is a second UE. In some examples, the transmitting device is a network node and where the receiving device is a UE.

In some cases, the configuration component 725, the selection component 730, the modulation component 735, the transmission component 740, the BLER component 745, the delta component 750, the report component 755, and the MCS component 760 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the configuration component 725, the selection component 730, the modulation component 735, the transmission component 740, the BLER component 745, the delta component 750, the report component 755, and the MCS component 760 discussed herein.

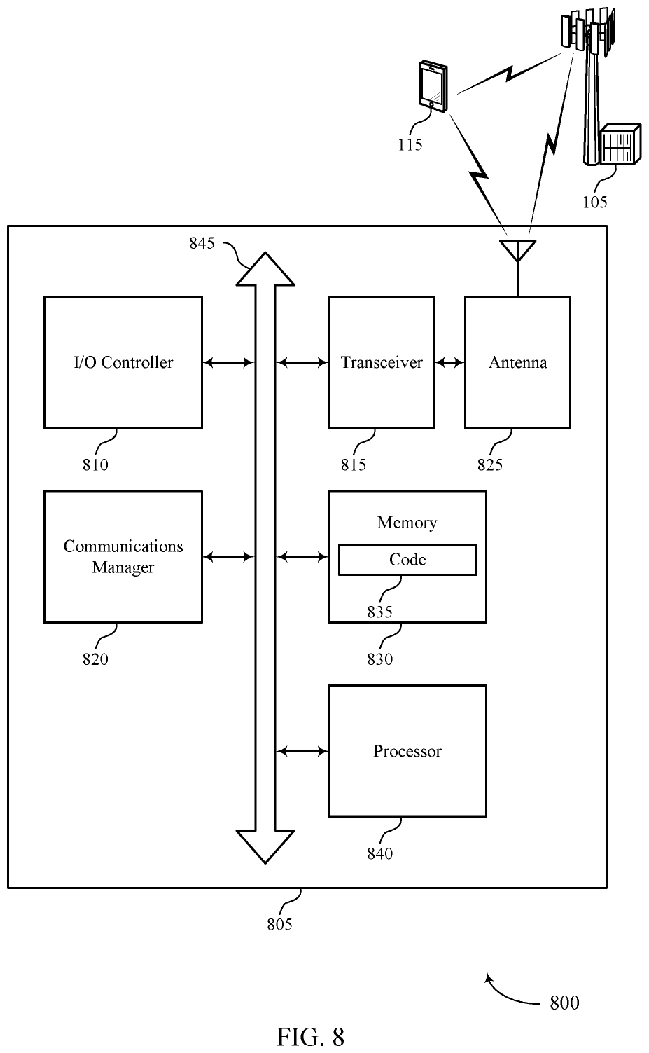

FIG. 8 shows a diagram of a system 800 including a device 805 that supports coding configurations to achieve PHY security in accordance with one or more aspects of the present disclosure. The device 805 may be an example of or include the components of a device 505, a device 605, or a transmitting device as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a BIOS which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting coding configurations to achieve PHY security). For example, the device 805 or a component of the device 805 may include a processor 840 and memory 830 coupled with or to the processor 840, the processor 840 and memory 830 configured to perform various functions described herein.

The communications manager 820 may support wireless communication at a transmitting device in accordance with examples as disclosed herein. For example, the communications manager 820 may be configured as or otherwise support a means for receiving control signaling indicating one or more configurations for modulating data. The communications manager 820 may be configured as or otherwise support a means for selecting a first configuration of the one or more configurations based on the control signaling, where the first configuration includes a mapping of constellation points to a single constellation point for transmitting the data in a message based on an MCS associated with a target secrecy BLER. The communications manager 820 may be configured as or otherwise support a means for modulating the data in accordance with the selected first configuration based on the mapping of the constellation points to achieve the target secrecy BLER. The communications manager 820 may be configured as or otherwise support a means for transmitting, to a receiving device, the message based on the modulated data.

By including or configuring the communications manager 820 in accordance with examples as described herein, the device 805 may support techniques for modulating data to achieve a target secrecy BLER, which may improve the security of communications between a transmitting device and a receiving device and reduce information leakage to eavesdroppers.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of coding configurations to achieve PHY security as described herein, or the processor 840 and the memory 830 may be otherwise configured to perform or support such operations.

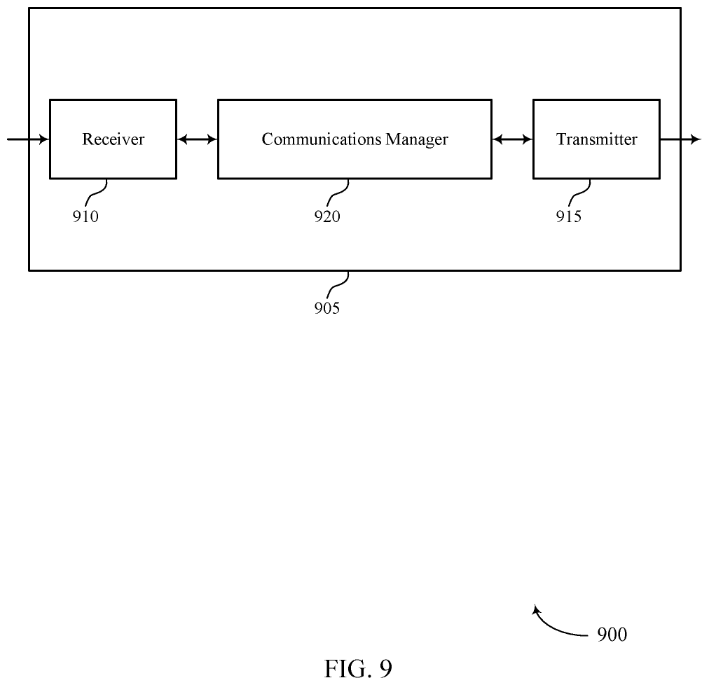

FIG. 9 shows a block diagram 900 of a device 905 that supports coding configurations to achieve PHY security in accordance with one or more aspects of the present disclosure. The device 905 may be an example of aspects of a receiving device as described herein. The device 905 may include a receiver 910, a transmitter 915, and a communications manager 920. The device 905 may also include one or more processors, memory coupled with the one or more processors, and instructions stored in the memory that are executable by the one or more processors to enable the one or more processors to perform the PHY security features discussed herein. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of coding configurations to achieve PHY security as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a receiving device in accordance with examples as disclosed herein. For example, the communications manager 920 may be configured as or otherwise support a means for receiving control signaling indicating one or more configurations for modulating data. The communications manager 920 may be configured as or otherwise support a means for receiving, from a transmitting device, a message based on a first configuration of the one or more configurations that includes a mapping of constellation points to a single constellation point for receiving the data in the message based on an MCS associated with a target secrecy BLER.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for modulating data to achieve a target secrecy BLER, which may improve the security of communications between a transmitting device and a receiving device and reduce information leakage to eavesdroppers.

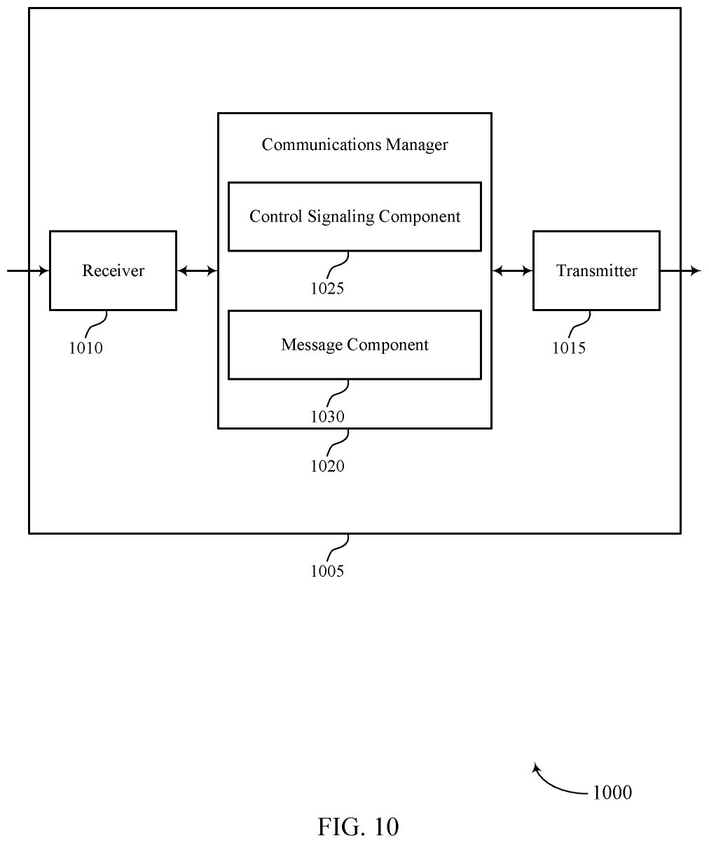

FIG. 10 shows a block diagram 1000 of a device 1005 that supports coding configurations to achieve PHY security in accordance with one or more aspects of the present disclosure. The device 1005 may be an example of aspects of a device 905 or a receiving device as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of coding configurations to achieve PHY security as described herein. For example, the communications manager 1020 may include a control signaling component 1025 a message component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a receiving device in accordance with examples as disclosed herein. The control signaling component 1025 may be configured as or otherwise support a means for receiving control signaling indicating one or more configurations for modulating data. The message component 1030 may be configured as or otherwise support a means for receiving, from a transmitting device, a message based on a first configuration of the one or more configurations that includes a mapping of constellation points to a single constellation point for receiving the data in the message based on an MCS associated with a target secrecy BLER.

In some cases, the control signaling component 1025 and the message component 1030 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 1025 and the message component 1030 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

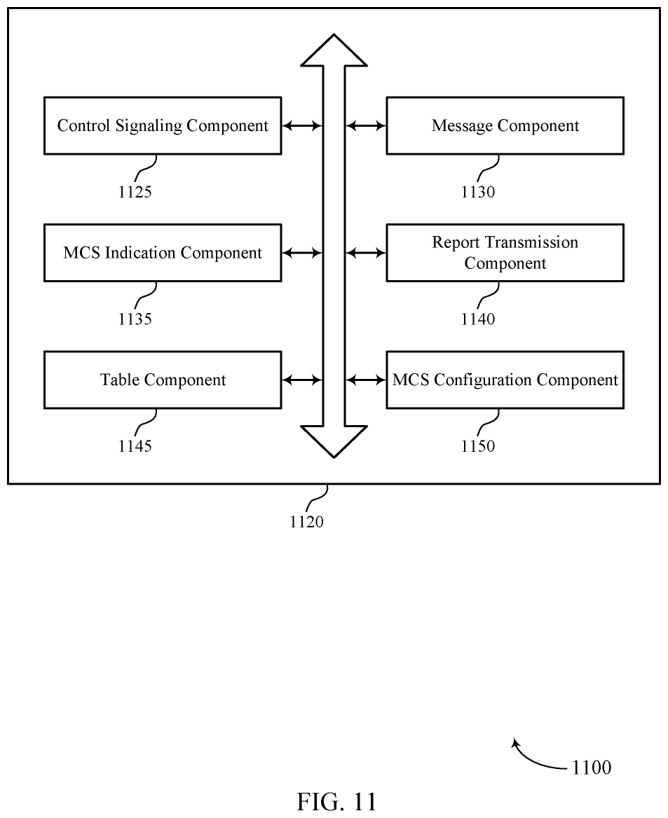

FIG. 11 shows a block diagram 1100 of a communications manager 1120 that supports coding configurations to achieve PHY security in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of coding configurations to achieve PHY security as described herein. For example, the communications manager 1120 may include a control signaling component 1125, a message component 1130, an MCS indication component 1135, a report transmission component 1140, a table component 1145, an MCS configuration component 1150, or any combination thereof. Each of these components may communicate, directly or indirectly, with one another (e.g., via one or more buses).

The communications manager 1120 may support wireless communication at a receiving device in accordance with examples as disclosed herein. The control signaling component 1125 may be configured as or otherwise support a means for receiving control signaling indicating one or more configurations for modulating data. The message component 1130 may be configured as or otherwise support a means for receiving, from a transmitting device, a message based on a first configuration of the one or more configurations that includes a mapping of constellation points to a single constellation point for receiving the data in the message based on an MCS associated with a target secrecy BLER.

In some examples, to support receiving the message, the message component 1130 may be configured as or otherwise support a means for receiving, from the transmitting device, the message based on a modulation of the data in accordance with a second MCS associated with a second secrecy rate that is higher than a first secrecy rate associated with a first MCS.

In some examples, to support receiving the control signaling, the MCS indication component 1135 may be configured as or otherwise support a means for receiving the control signaling indicating at least a first MCS, a second MCS, one or more delta MCSs for the second MCS relative to the first MCS, one or more delta modulation orders for the second MCS relative to the first MCS, or a combination thereof.

In some examples, the MCS indication component 1135 may be configured as or otherwise support a means for receiving, from the transmitting device, a message indicating a selected delta MCS of the one or more delta MCSs based on the control signaling.

In some examples, to support receiving the control signaling, the control signaling component 1125 may be configured as or otherwise support a means for receiving the control signaling indicating a delta MCS for at least a data security level, a data security priority, a data priority, a PDB, a delay of the data, or a combination thereof.

In some examples, the report transmission component 1140 may be configured as or otherwise support a means for transmitting, to the transmitting device, a report indicating a set of CQIs and a set of corresponding MCSs, where a first CQI of the set of CQIs and a first MCS of the set of corresponding MCSs are associated with a secrecy rate based on the target secrecy BLER.

In some examples, the report transmission component 1140 may be configured as or otherwise support a means for transmitting, to the transmitting device, a report indicating at least a set of delta MCSs, a set of delta CQIs, or both.

In some examples, the report transmission component 1140 may be configured as or otherwise support a means for transmitting, to the transmitting device, a configuration message indicating a configuration of at least the set of delta MCSs, the set of delta CQIs, or both for a resource pool based on at least a security priority, a security level, a data priority, a PDB, or a combination thereof.

In some examples, the table component 1145 may be configured as or otherwise support a means for transmitting, to the transmitting device, a report indicating a set of MCS tables and a set of BLERs, where the set of BLERs includes a secrecy BLER and a link BLER.

In some examples, the MCS configuration component 1150 may be configured as or otherwise support a means for receiving, from the transmitting device, control signaling indicating a configuration of at least one or more MCSs, one or more delta MCSs, or both.

In some examples, the MCS configuration component 1150 may be configured as or otherwise support a means for transmitting, to the transmitting device, control signaling indicating a configuration of at least one or more MCSs, one or more delta MCSs, or both.

In some examples, the transmitting device is a first UE and where the receiving device is a second UE. In some examples, the transmitting device is a network node and where the receiving device is a UE.

In some cases, the control signaling component 1125, the message component 1130, the MCS indication component 1135, the report transmission component 1140, the table component 1145, and the MCS configuration component 1150 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling component 1125, the message component 1130, the MCS indication component 1135, the report transmission component 1140, the table component 1145, and the MCS configuration component 1150 discussed herein.

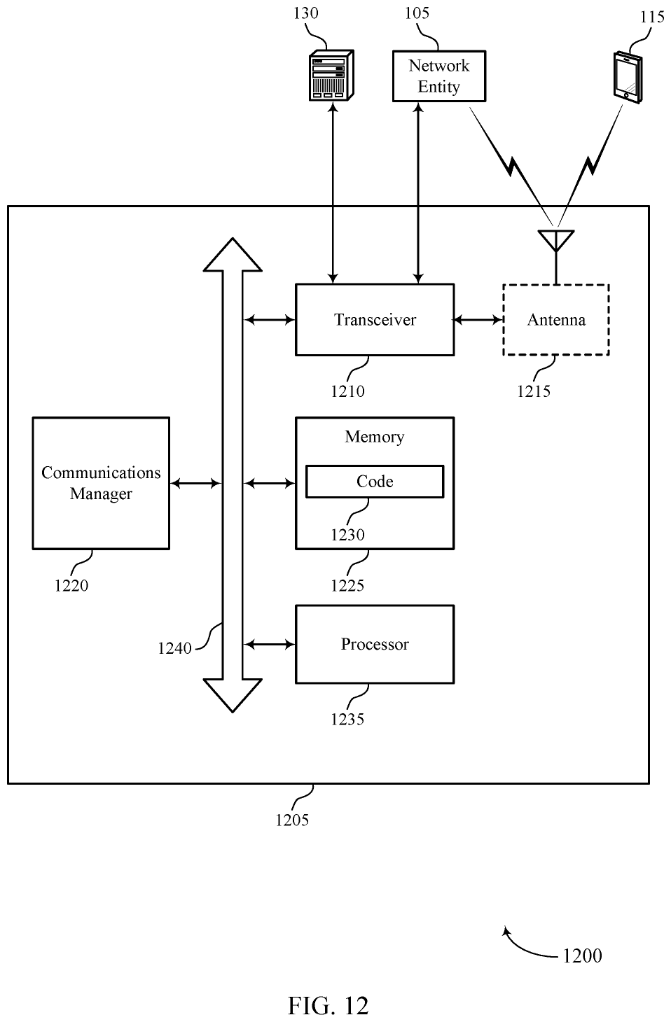

FIG. 12 shows a diagram of a system 1200 including a device 1205 that supports coding configurations to achieve PHY security in accordance with one or more aspects of the present disclosure. The device 1205 may be an example of or include the components of a device 905, a device 1005, or a receiving device as described herein. The device 1205 may include components for bi-directional voice and data communications including components for transmitting and receiving communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting coding configurations to achieve PHY security). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a receiving device in accordance with examples as disclosed herein. For example, the communications manager 1220 may be configured as or otherwise support a means for receiving control signaling indicating one or more configurations for modulating data. The communications manager 1220 may be configured as or otherwise support a means for receiving, from a transmitting device, a message based on a first configuration of the one or more configurations that includes a mapping of constellation points to a single constellation point for receiving the data in the message based on an MCS associated with a target secrecy BLER.

By including or configuring the communications manager 1220 in accordance with examples as described herein, the device 1205 may support techniques for modulating data to achieve a target secrecy BLER, which may improve the security of communications between a transmitting device and a receiving device and reduce information leakage to eavesdroppers.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of coding configurations to achieve PHY security as described herein, or the processor 1235 and the memory 1225 may be otherwise configured to perform or support such operations.

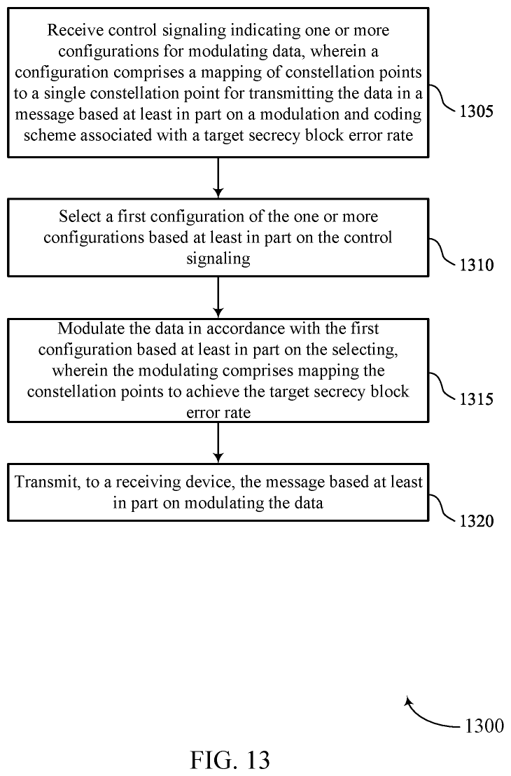

FIG. 13 shows a flowchart illustrating a method 1300 that supports coding configurations to achieve PHY security in accordance with one or more aspects of the present disclosure. The operations of the method 1300 may be implemented by a transmitting device or its components as described herein. For example, the operations of the method 1300 may be performed by a transmitting device as described with reference to FIGS. 1 through 8. In some examples, a transmitting device may execute a set of instructions to control the functional elements of the transmitting device to perform the described functions. Additionally, or alternatively, the transmitting device may perform aspects of the described functions using special-purpose hardware.

At 1305, the method may include receiving control signaling indicating one or more configurations for modulating data. The operations of 1305 may be performed in accordance with examples as disclosed herein. In some examples, aspects of the operations of 1305 may be performed by a configuration component 725 as described with reference to FIG. 7.

At 1310, the method may include selecting a first configuration of the one or more configurations based on the control signaling, where the first configuration comprises a mapping of constellation points to a single constellation point for transmitting the data in a message based on an MCS associated with a target secrecy BLER. The operations of 1310 may be performed in accordance with examples as disclosed herein. In some examples, aspects of the operations of 1310 may be performed by a selection component 730 as described with reference to FIG. 7.

At 1315, the method may include modulating the data in accordance with the selected first configuration based on the mapping of the constellation points to achieve the target secrecy BLER. The operations of 1315 may be performed in accordance with examples as disclosed herein. In some examples, aspects of the operations of 1315 may be performed by a modulation component 735 as described with reference to FIG. 7.

At 1320, the method may include transmitting, to a receiving device, the message based on the modulated data. The operations of 1320 may be performed in accordance with examples as disclosed herein. In some examples, aspects of the operations of 1320 may be performed by a transmission component 740 as described with reference to FIG. 7.

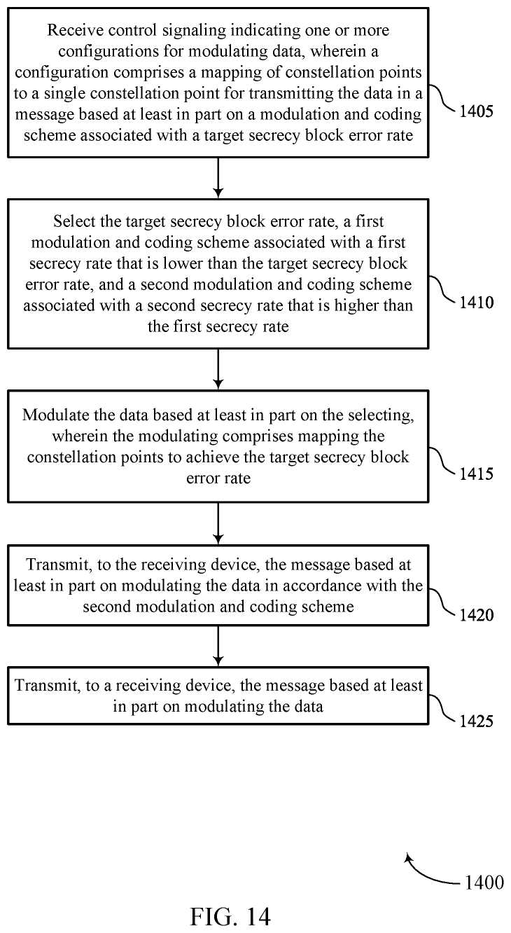

FIG. 14 shows a flowchart illustrating a method 1400 that supports coding configurations to achieve PHY security in accordance with one or more aspects of the present disclosure. The operations of the method 1400 may be implemented by a transmitting device or its components as described herein. For example, the operations of the method 1400 may be performed by a transmitting device as described with reference to FIGS. 1 through 8. In some examples, a transmitting device may execute a set of instructions to control the functional elements of the transmitting device to perform the described functions. Additionally, or alternatively, the transmitting device may perform aspects of the described functions using special-purpose hardware.

At 1405, the method may include receiving control signaling indicating one or more configurations for modulating data. The operations of 1405 may be performed in accordance with examples as disclosed herein. In some examples, aspects of the operations of 1405 may be performed by a configuration component 725 as described with reference to FIG. 7.

At 1410, the method may include selecting the target secrecy BLER, a first MCS associated with a first secrecy rate that is lower than the target secrecy BLER, and a second MCS associated with a second secrecy rate that is higher than the first secrecy rate. The operations of 1410 may be performed in accordance with examples as disclosed herein. In some examples, aspects of the operations of 1410 may be performed by a BLER component 745 as described with reference to FIG. 7.

At 1415, the method may include modulating the data in accordance with the selected first configuration based on the mapping of the constellation points to achieve the target secrecy BLER. The operations of 1415 may be performed in accordance with examples as disclosed herein. In some examples, aspects of the operations of 1415 may be performed by a modulation component 735 as described with reference to FIG. 7.

At 1420, the method may include transmitting, to the receiving device, the message based a modulation of the data in accordance with the second MCS. The operations of 1420 may be performed in accordance with examples as disclosed herein. In some examples, aspects of the operations of 1420 may be performed by a transmission component 740 as described with reference to FIG. 7.

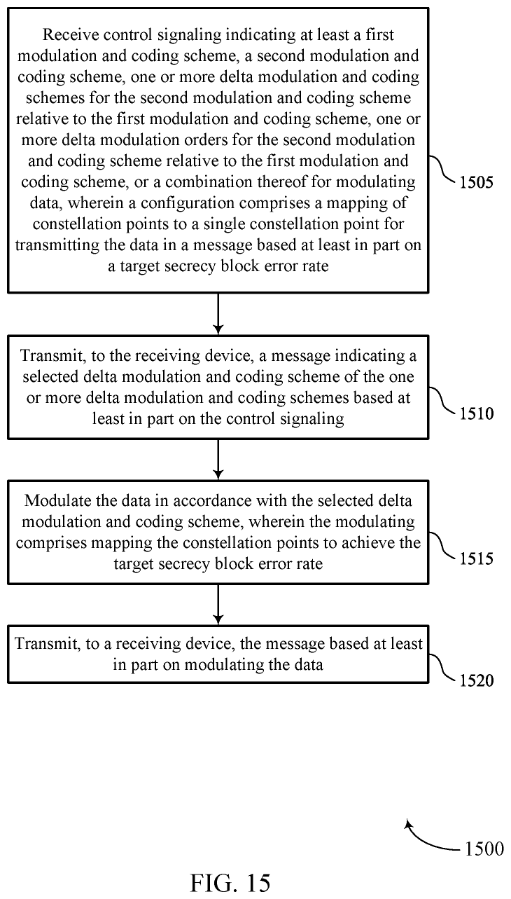

FIG. 15 shows a flowchart illustrating a method 1500 that supports coding configurations to achieve PHY security in accordance with one or more aspects of the present disclosure. The operations of the method 1500 may be implemented by a transmitting device or its components as described herein. For example, the operations of the method 1500 may be performed by a transmitting device as described with reference to FIGS. 1 through 8. In some examples, a transmitting device may execute a set of instructions to control the functional elements of the transmitting device to perform the described functions. Additionally, or alternatively, the transmitting device may perform aspects of the described functions using special-purpose hardware.

At 1505, the method may include receiving control signaling indicating at least a first MCS, a second MCS, one or more delta MCSs for the second MCS relative to the first MCS, one or more delta modulation orders for the second MCS relative to the first MCS, or a combination thereof for modulating data, where a configuration includes a mapping of constellation points to a single constellation point for transmitting the data in a message based on a target secrecy BLER. The operations of 1505 may be performed in accordance with examples as disclosed herein. In some examples, aspects of the operations of 1505 may be performed by a delta component 750 as described with reference to FIG. 7.

At 1510, the method may include transmitting, to the receiving device, a message indicating a selected delta MCS of the one or more delta MCSs based on the control signaling. The operations of 1510 may be performed in accordance with examples as disclosed herein. In some examples, aspects of the operations of 1510 may be performed by a delta component 750 as described with reference to FIG. 7.

At 1515, the method may include modulating the data in accordance with the selected delta MCS, where the modulating includes mapping the constellation points to achieve the target secrecy BLER. The operations of 1515 may be performed in accordance with examples as disclosed herein. In some examples, aspects of the operations of 1515 may be performed by a modulation component 735 as described with reference to FIG. 7.

At 1520, the method may include transmitting, to a receiving device, the message based on the modulated data. The operations of 1520 may be performed in accordance with examples as disclosed herein. In some examples, aspects of the operations of 1520 may be performed by a transmission component 740 as described with reference to FIG. 7.

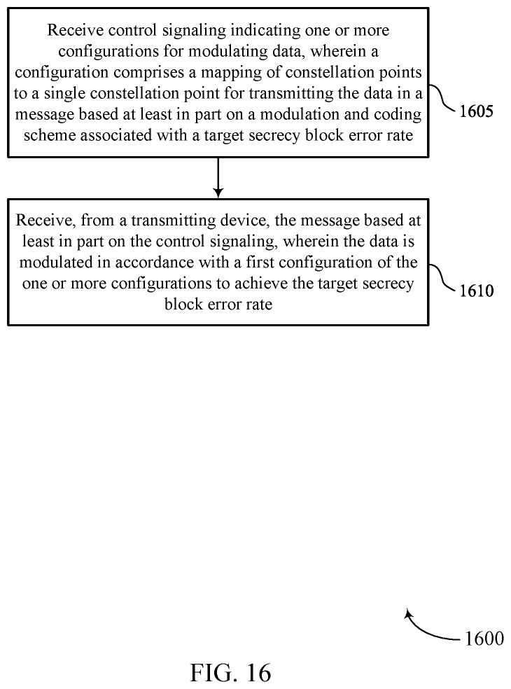

FIG. 16 shows a flowchart illustrating a method 1600 that supports coding configurations to achieve PHY security in accordance with one or more aspects of the present disclosure. The operations of the method 1600 may be implemented by a receiving device or its components as described herein. For example, the operations of the method 1600 may be performed by a receiving device as described with reference to FIGS. 1 through 4 and 9 through 12. In some examples, a receiving device may execute a set of instructions to control the functional elements of the receiving device to perform the described functions. Additionally, or alternatively, the receiving device may perform aspects of the described functions using special-purpose hardware.

At 1605, the method may include receiving control signaling indicating one or more configurations for modulating data. The operations of 1605 may be performed in accordance with examples as disclosed herein. In some examples, aspects of the operations of 1605 may be performed by a control signaling component 1125 as described with reference to FIG. 11.

At 1610, the method may include receiving, from a transmitting device, a message based on a first configuration of the one or more configurations that includes a mapping of constellation points to a single constellation point for receiving the data in the message based on an MCS associated with a target secrecy BLER. The operations of 1610 may be performed in accordance with examples as disclosed herein. In some examples, aspects of the operations of 1610 may be performed by a message component 1130 as described with reference to FIG. 11.

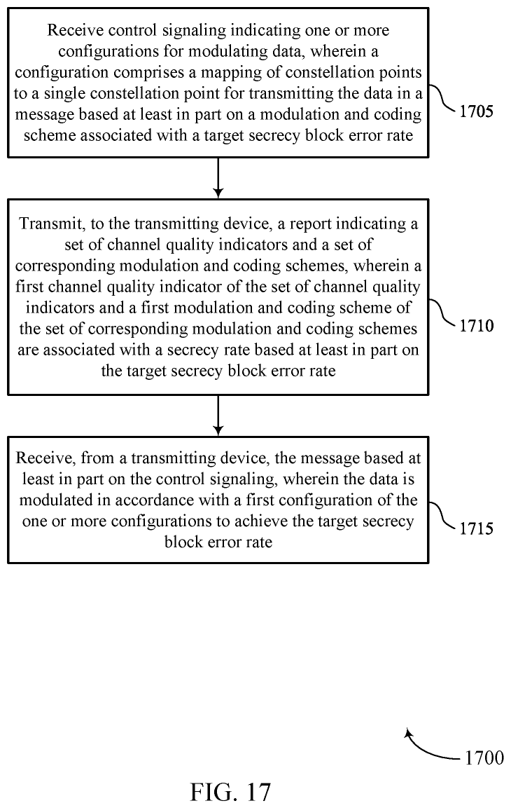

FIG. 17 shows a flowchart illustrating a method 1700 that supports coding configurations to achieve PHY security in accordance with one or more aspects of the present disclosure. The operations of the method 1700 may be implemented by a receiving device or its components as described herein. For example, the operations of the method 1700 may be performed by a receiving device as described with reference to FIGS. 1 through 4 and 9 through 12. In some examples, a receiving device may execute a set of instructions to control the functional elements of the receiving device to perform the described functions. Additionally, or alternatively, the receiving device may perform aspects of the described functions using special-purpose hardware.

At 1705, the method may include receiving control signaling indicating one or more configurations for modulating data. The operations of 1705 may be performed in accordance with examples as disclosed herein. In some examples, aspects of the operations of 1705 may be performed by a control signaling component 1125 as described with reference to FIG. 11.

At 1710, the method may include transmitting, to the transmitting device, a report indicating a set of CQIs and a set of corresponding MCSs, where a first CQI of the set of CQIs and a first MCS of the set of corresponding MCSs are associated with a secrecy rate based on the target secrecy BLER. The operations of 1710 may be performed in accordance with examples as disclosed herein. In some examples, aspects of the operations of 1710 may be performed by a report transmission component 1140 as described with reference to FIG. 11.

At 1715, the method may include receiving, from a transmitting device, the message based on a modulation of the data in accordance with a first configuration of the one or more configurations to achieve the target secrecy BLER. The operations of 1715 may be performed in accordance with examples as disclosed herein. In some examples, aspects of the operations of 1715 may be performed by a message component 1130 as described with reference to FIG. 11.

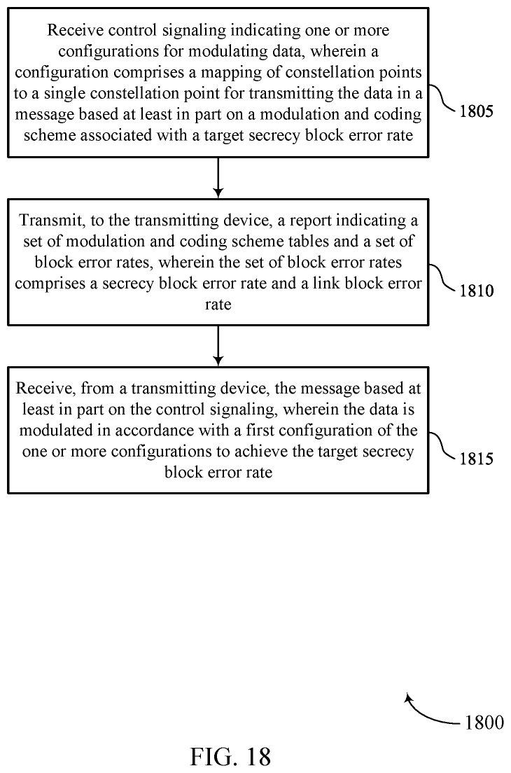

FIG. 18 shows a flowchart illustrating a method 1800 that supports coding configurations to achieve PHY security in accordance with one or more aspects of the present disclosure. The operations of the method 1800 may be implemented by a receiving device or its components as described herein. For example, the operations of the method 1800 may be performed by a receiving device as described with reference to FIGS. 1 through 4 and 9 through 12. In some examples, a receiving device may execute a set of instructions to control the functional elements of the receiving device to perform the described functions. Additionally, or alternatively, the receiving device may perform aspects of the described functions using special-purpose hardware.

At 1805, the method may include receiving control signaling indicating one or more configurations for modulating data. The operations of 1805 may be performed in accordance with examples as disclosed herein. In some examples, aspects of the operations of 1805 may be performed by a control signaling component 1125 as described with reference to FIG. 11.

At 1810, the method may include transmitting, to the transmitting device, a report indicating a set of MCS tables and a set of BLERs, where the set of BLERs includes a secrecy BLER and a link BLER. The operations of 1810 may be performed in accordance with examples as disclosed herein. In some examples, aspects of the operations of 1810 may be performed by a table component 1145 as described with reference to FIG. 11.

At 1815, the method may include receiving, from a transmitting device, the message based on a modulation of the data in accordance with a first configuration of the one or more configurations to achieve the target secrecy BLER. The operations of 1815 may be performed in accordance with examples as disclosed herein. In some examples, aspects of the operations of 1815 may be performed by a message component 1130 as described with reference to FIG. 11.

The following provides an overview of aspects of the present disclosure:

Aspect 1: A method for wireless communication at a transmitting device, comprising: receiving control signaling indicating one or more configurations for modulating data; selecting a first configuration of the one or more configurations based at least in part on the control signaling, wherein the first configuration comprises a mapping of constellation points to a single constellation point for transmitting the data in a message based at least in part on a modulation and coding scheme associated with a target secrecy block error rate; modulating the data in accordance with the selected first configuration based at least in part on the mapping of the constellation points to achieve the target secrecy BLER; and transmitting, to a receiving device, the message based at least in part on the modulated data.

Aspect 2: The method of aspect 1, further comprising: selecting the target secrecy BLER, a first modulation and coding scheme associated with a first secrecy rate that is lower than the target secrecy BLER, and a second modulation and coding scheme associated with a second secrecy rate that is higher than the first secrecy rate; and transmitting, to the receiving device, the message based at least in part on data modulation of the data in accordance with the second modulation and coding scheme.

Aspect 3: The method of any of aspects 1 through 2, wherein receiving the control signaling comprises: receiving the control signaling indicating at least a first modulation and coding scheme, a second modulation and coding scheme, one or more delta MCSs for the second modulation and coding scheme relative to the first modulation and coding scheme, one or more delta modulation orders for the second modulation and coding scheme relative to the first modulation and coding scheme, or a combination thereof.

Aspect 4: The method of aspect 3, further comprising: transmitting, to the receiving device, a message indicating a selected delta MCS of the one or more delta MCSs based at least in part on the control signaling.

Aspect 5: The method of any of aspects 1 through 4, wherein receiving the control signaling comprises: receiving the control signaling indicating a delta MCS for at least a data security level, a data security priority, a data priority, a PDB, a delay of the data, or a combination thereof.

Aspect 6: The method of any of aspects 1 through 5, further comprising: receiving, from the receiving device, a report indicating a set of CQIs and a set of corresponding modulation and coding schemes, wherein a first CQI of the set of CQIs and a first modulation and coding scheme of the set of corresponding modulation and coding schemes are associated with a secrecy rate based at least in part on the target secrecy BLER.

Aspect 7: The method of any of aspects 1 through 6, further comprising: receiving, from the receiving device, a report indicating at least a set of delta MCSs, a set of delta CQIs, or both.

Aspect 8: The method of aspect 7, further comprising: transmitting, to the receiving device, a configuration message indicating a configuration of at least the set of delta MCSs, the set of delta CQIs, or both for a resource pool based at least in part on at least a security priority, a security level, a data priority, a PDB, or a combination thereof.

Aspect 9: The method of any of aspects 1 through 8, further comprising: receiving, from the receiving device, a report indicating a set of modulation and coding scheme tables and a set of BLERs, wherein the set of BLERs comprises a secrecy BLER and a link BLER.

Aspect 10: The method of any of aspects 1 through 9, further comprising: transmitting, to the receiving device, control signaling indicating a configuration of at least one or more modulation and coding schemes, one or more delta MCSs, or both.

Aspect 11: The method of any of aspects 1 through 10, further comprising: receiving, from the receiving device, control signaling indicating a configuration of at least one or more modulation and coding schemes, one or more delta MCSs, or both.

Aspect 12: The method of any of aspects 1 through 11, wherein the transmitting device is a first UE and wherein the receiving device is a second UE.

Aspect 13: The method of any of aspects 1 through 12, wherein the transmitting device is a network entity and wherein the receiving device is a UE.

Aspect 14: A method for wireless communication at a receiving device, comprising: receiving control signaling indicating one or more configurations for modulating data; and receiving, from a transmitting device, the message based at least in part on a first configuration of the one or more configurations that comprises a mapping of constellation points to a single constellation point for receiving the data in the message based at least in part on a modulation and coding scheme associated with a target secrecy BLER.

Aspect 15: The method of aspect 14, wherein receiving the message comprises: receiving, from the transmitting device, the message based at least in part on a modulation of the data in accordance with a second modulation and coding scheme associated with a second secrecy rate that is higher than a first secrecy rate associated with a first modulation and coding scheme.

Aspect 16: The method of any of aspects 14 through 15, wherein receiving the control signaling comprises: receiving the control signaling indicating at least a first modulation and coding scheme, a second modulation and coding scheme, one or more delta MCSs for the second modulation and coding scheme relative to the first modulation and coding scheme, one or more delta modulation orders for the second modulation and coding scheme relative to the first modulation and coding scheme, or a combination thereof.

Aspect 17: The method of aspect 16, further comprising: receiving, from the transmitting device, a message indicating a selected delta MCS of the one or more delta MCSs based at least in part on the control signaling.

Aspect 18: The method of any of aspects 14 through 17, wherein receiving the control signaling comprises: receiving the control signaling indicating a delta MCS for at least a data security level, a data security priority, a data priority, a PDB, a delay of the data, or a combination thereof.

Aspect 19: The method of any of aspects 14 through 18, further comprising: transmitting, to the transmitting device, a report indicating a set of CQIs and a set of corresponding modulation and coding schemes, wherein a first CQI of the set of CQIs and a first modulation and coding scheme of the set of corresponding modulation and coding schemes are associated with a secrecy rate based at least in part on the target secrecy BLER.

Aspect 20: The method of any of aspects 14 through 19, further comprising: transmitting, to the transmitting device, a report indicating at least a set of delta MCSs, a set of delta CQIs, or both.

Aspect 21: The method of aspect 20, further comprising: transmitting, to the transmitting device, a configuration message indicating a configuration of at least the set of delta MCSs, the set of delta CQIs, or both for a resource pool based at least in part on at least a security priority, a security level, a data priority, a PDB, or a combination thereof.

Aspect 22: The method of any of aspects 14 through 21, further comprising: transmitting, to the transmitting device, a report indicating a set of modulation and coding scheme tables and a set of BLERs, wherein the set of BLERs comprises a secrecy BLER and a link BLER.

Aspect 23: The method of any of aspects 14 through 22, further comprising: receiving, from the transmitting device, control signaling indicating a configuration of at least one or more modulation and coding schemes, one or more delta MCSs, or both.

Aspect 24: The method of any of aspects 14 through 23, further comprising: transmitting, to the transmitting device, control signaling indicating a configuration of at least one or more modulation and coding schemes, one or more delta MCSs, or both.

Aspect 25: The method of any of aspects 14 through 24, wherein the transmitting device is a first UE and wherein the receiving device is a second UE.

Aspect 26: The method of any of aspects 14 through 25, wherein the transmitting device is a network entity and wherein the receiving device is a UE.

Aspect 27: An apparatus for wireless communication at a transmitting device, comprising a processor; memory coupled with the processor; and instructions stored in the memory and executable by the processor to cause the apparatus to perform a method of any of aspects 1 through 13.

Aspect 28: An apparatus for wireless communication at a transmitting device, comprising at least one means for performing a method of any of aspects 1 through 13.

Aspect 29: A non-transitory computer-readable medium storing code for wireless communication at a transmitting device, the code comprising instructions executable by a processor to perform a method of any of aspects 1 through 13.

Aspect 30: An apparatus for wireless communication at a receiving device, comprising a processor; memory coupled with the processor; and instructions stored in the memory and executable by the processor to cause the apparatus to perform a method of any of aspects 14 through 26.

Aspect 31: An apparatus for wireless communication at a receiving device, comprising at least one means for performing a method of any of aspects 14 through 26.

Aspect 32: A non-transitory computer-readable medium storing code for wireless communication at a receiving device, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a transmitting device, comprising:
a processor;
memory coupled with the processor; and
instructions stored in the memory and executable by the processor to cause the apparatus to:
receive control signaling indicating one or more configurations for modulating data;
select a first configuration of the one or more configurations based at least in part on the control signaling, wherein the first configuration comprises a mapping of constellation points to a single constellation point for transmitting the data in a message based at least in part on a modulation and coding scheme associated with a target secrecy block error rate;
modulate the data in accordance with the selected first configuration based at least in part on the mapping of the constellation points to achieve the target secrecy block error rate; and
transmit, to a receiving device, the message based at least in part on the modulated data.

2. The apparatus of claim 1, wherein the instructions are further executable by the processor to:
select the target secrecy block error rate, a first modulation and coding scheme associated with a first secrecy rate that is lower than the target secrecy block error rate, and a second modulation and coding scheme associated with a second secrecy rate that is higher than the first secrecy rate; and
transmit, to the receiving device, the message based at least in part on a modulation of the data in accordance with the second modulation and coding scheme.

3. The apparatus of claim 1, wherein the instructions are further executable by the processor to receive the control signaling by being executable by the processor to:
receive the control signaling indicating at least a first modulation and coding scheme, a second modulation and coding scheme, one or more delta modulation and coding schemes for the second modulation and coding scheme relative to the first modulation and coding scheme, one or more delta modulation orders for the second modulation and coding scheme relative to the first modulation and coding scheme, or a combination thereof.

4. The apparatus of claim 3, wherein the instructions are further executable by the processor to:
transmit, to the receiving device, a message indicating a selected delta modulation and coding scheme of the one or more delta modulation and coding schemes based at least in part on the control signaling.

5. The apparatus of claim 1, wherein the instructions are further executable by the processor to receive the control signaling by being executable by the processor to:
receive the control signaling indicating a delta modulation and coding scheme for at least a data security level, a data security priority, a data priority, a packet delay budget, a delay of the data, or a combination thereof.

6. The apparatus of claim 1, wherein the instructions are further executable by the processor to:
receive, from the receiving device, a report indicating a set of channel quality indicators and a set of corresponding modulation and coding schemes, wherein a first channel quality indicator of the set of channel quality indicators and a first modulation and coding scheme of the set of corresponding modulation and coding schemes are associated with a secrecy rate based at least in part on the target secrecy block error rate.

7. The apparatus of claim 1, wherein the instructions are further executable by the processor to:
receive, from the receiving device, a report indicating at least a set of delta modulation and coding schemes, a set of delta channel quality indicators, or both.

8. The apparatus of claim 7, wherein the instructions are further executable by the processor to:
transmit, to the receiving device, a configuration message indicating a configuration of at least the set of delta modulation and coding schemes, the set of delta channel quality indicators, or both for a resource pool based at least in part on at least a security priority, a security level, a data priority, a packet delay budget, or a combination thereof.

9. The apparatus of claim 1, wherein the instructions are further executable by the processor to:
receive, from the receiving device, a report indicating a set of modulation and coding scheme tables and a set of block error rates, wherein the set of block error rates comprises a secrecy block error rate and a link block error rate.

10. The apparatus of claim 1, wherein the instructions are further executable by the processor to:
transmit, to the receiving device, control signaling indicating a configuration of at least one or more modulation and coding schemes, one or more delta modulation and coding schemes, or both; or
receive, from the receiving device, control signaling indicating a configuration of at least one or more modulation and coding schemes, one or more delta modulation and coding schemes, or both.

11-13. (canceled)

14. An apparatus for wireless communication at a receiving device, comprising:
a processor;
memory coupled with the processor; and
instructions stored in the memory and executable by the processor to cause the apparatus to:
receive control signaling indicating one or more configurations for modulating data; and
receive, from a transmitting device, a message based at least in part on a first configuration of the one or more configurations that comprises a mapping of constellation points to a single constellation point for receiving the data in the message based at least in part on a modulation and coding scheme associated with a target secrecy block error rate.

15. The apparatus of claim 14, wherein the instructions are further executable by the processor to receive the message by being executable by the processor to:
receive, from the transmitting device, the message based at least in part on a modulation of the data in accordance with a second modulation and coding scheme associated with a second secrecy rate that is higher than a first secrecy rate associated with a first modulation and coding scheme.

16. The apparatus of claim 14, wherein the instructions are further executable by the processor to receive the message by being executable by the processor to:
receive the control signaling indicating at least a first modulation and coding scheme, a second modulation and coding scheme, one or more delta modulation and coding schemes for the second modulation and coding scheme relative to the first modulation and coding scheme, one or more delta modulation orders for the second modulation and coding scheme relative to the first modulation and coding scheme, or a combination thereof; and
receive, from the transmitting device, a message indicating a selected delta modulation and coding scheme of the one or more delta modulation and coding schemes based at least in part on the control signaling.

17. (canceled)

18. The apparatus of claim 14, wherein the instructions are further executable by the processor to receive the message by being executable by the processor to:
receive the control signaling indicating a delta modulation and coding scheme for at least a data security level, a data security priority, a data priority, a packet delay budget, a delay of the data, or a combination thereof.

19. The apparatus of claim 14, wherein the instructions are further executable by the processor to:
transmit, to the transmitting device, a report indicating a set of channel quality indicators and a set of corresponding modulation and coding schemes, wherein a first channel quality indicator of the set of channel quality indicators and a first modulation and coding scheme of the set of corresponding modulation and coding schemes are associated with a secrecy rate based at least in part on the target secrecy block error rate.

20. The apparatus of claim 14, wherein the instructions are further executable by the processor to:
transmit, to the transmitting device, a report indicating at least a set of delta modulation and coding schemes, a set of delta channel quality indicators, or both; and
transmit, to the transmitting device, a configuration message indicating a configuration of at least the set of delta modulation and coding schemes, the set of delta channel quality indicators, or both for a resource pool based at least in part on at least a security priority, a security level, a data priority, a packet delay budget, or a combination thereof.

21. (canceled)

22. The apparatus of claim 14, wherein the instructions are further executable by the processor to:
transmit, to the transmitting device, a report indicating a set of modulation and coding scheme tables and a set of block error rates, wherein the set of block error rates comprises a secrecy block error rate and a link block error rate.

23. The apparatus of claim 14, wherein the instructions are further executable by the processor to:
receive, from the transmitting device, control signaling indicating a configuration of at least one or more modulation and coding schemes, one or more delta modulation and coding schemes, or both; or
transmit, to the transmitting device, control signaling indicating a configuration of at least one or more modulation and coding schemes, one or more delta modulation and coding schemes, or both.

24-26. (canceled)

27. A method for wireless communication at a transmitting device, comprising:
receiving control signaling indicating one or more configurations for modulating data;
selecting a first configuration of the one or more configurations based at least in part on the control signaling, wherein the first configuration comprises a mapping of constellation points to a single constellation point for transmitting the data in a message based at least in part on a modulation and coding scheme associated with a target secrecy block error rate;
modulating the data in accordance with the selected first configuration based at least in part on the mapping of the constellation points to achieve the target secrecy block error rate; and
transmitting, to a receiving device, the message based at least in part on the modulated data.

28. The method of claim 27, further comprising:
selecting the target secrecy block error rate, a first modulation and coding scheme associated with a first secrecy rate that is lower than the target secrecy block error rate, and a second modulation and coding scheme associated with a second secrecy rate that is higher than the first secrecy rate; and
transmitting, to the receiving device, the message based at least in part on a modulation of the data in accordance with the second modulation and coding scheme.

29-30. (canceled)
